(19) United States
(12) Patent Application Publication
(10) Pub. No.: US 2009/0202134 A1
(43) Pub. Date: Aug. 13, 2009

(54) PRINT INSPECTING APPARATUS

(75) Inventors: Keisaku KANO, Takasaki-shi (JP); Yasuo Nishimura, Ichikawa-shi (JP); Kei Matsueda, Matsudo-shi (JP); Junichi Takemura, Nishitokyo-shi (JP); Toru Kitta, Fuefuki-shi (JP)

Correspondence Address: BUCHANAN, INGERSOLL & ROONEY PC, POST OFFICE BOX 1404, ALEXANDRIA, VA, 22313-1404, US

(73) Assignees: Glory Ltd., Himeji (JP); Nisca Corporation, Minamikoma-gun (JP)

(21) Appl. No.: 12/342,970

(22) Filed: Dec. 23, 2008

(30) Foreign Application Priority Data
Dec. 28, 2007 (JP) 2007-338513
Dec. 28, 2007 (JP) 2007-338571
Dec. 28, 2007 (JP) 2007-338660

(51) Int. Cl. G06K 9/00

(52) U.S. Cl. 382/141

(57) ABSTRACT

A print inspecting apparatus capable of identifying a page of a form corresponding to a clipped image without requiring a special barcode or printing, is provided. A print inspecting apparatus 1 acquires correct solution information which is associated with plural inspection areas EF and barcode area BC in one page and page information, and includes an inspection server 31 which sets plural areas to be clipped from the image corresponding to the inspection areas, a conveying motor which conveys the form in one direction; line scan cameras which read the image of the form, and inspecting terminals 32 which clips plural of areas from the image read by the camera to decode the image, and determine that the character string in the plurality of inspection areas falls under that of what page in the form, based on the decoded character string in the inspection area and the correct solution information.

### FIELD OF THE INVENTION

The present invention relates to a print inspecting apparatus, and in particular to a print inspecting apparatus which inspects characters printed on a form or sheet by a printer.

### DESCRIPTION OF THE RELATED ART

For example, bank statements or invoices monthly issued by financial institutes or the like are sent or mailed to respective customers after characters (including numerals) and symbols (hereinafter, simply called as “characters”) are printed on predetermined forms such as a fan-folded paper by a printing apparatus (printer), respective forms are cut to individual forms by a post-processing apparatus, individual forms are folded as necessary, and they are automatically enclosed in envelopes by an inserting apparatus. Among them, when there are many statements or the like to be issued, a system printer which allows fast printing at high precision is used.

However, even if a high precision printer such as a system printer is used, a print defect due to printer failure, paper quality, print environment or the like, such as irregularities, density differences (character thinning, blur, character thickening, or character collapse), character omission, or character skew of characters printed on the form occurs.

A print inspecting apparatus is known in which a mark for a page image clipping (start mark, end mark) and a barcode having page information are provided in a form, an image by each page is clipped by recognizing the mark by an image process, and further, an inspection of each character in an inspection area is performed after clipping the inspection area from the image for one page so as to prevent the print defect (e.g., see JP-A-2007-172027). Besides, a printing system is also known in which a form size is set as already-known information, and an image of a predetermined conveying section is clipped by monitoring a conveying amount of the form (e.g., see JP-A-2002-86831).

As an inspecting method in the print inspecting apparatus and the printing system, a bitmap matching of a form page image, an OCR of an inspection area (e.g., see JP-A-2001-283151), or a collation by a feature amount (e.g., see JP-A-2007-172027) can be used. In the OCR inspection or the collation by the feature amount, acceptance or non-acceptance is determined based on an image of the area to be inspected of the form page image and data for inspection (correct solution information) prepared in advance. Accordingly, a linkage between the read form page image and a correct solution page data to inspect it is absolutely necessary to perform the inspection.

As technologies for the linkage as stated above, a technology sequentially linking the read form page image and the correct solution page data, a page identifying technology to identify the page by a barcode (e.g., see JP-B-2760803) and so on are used.

However, in the technology performing the linkage sequentially, it is necessary to examine the first page from among a lot of printed forms and to designate a beginning correct solution page data in the first page accurately. Accordingly, if a selection of the first page having correct solution page data is not correct, all pages are not accepted. Besides, a special printing to recognize a page is necessary for the barcode and the character OCR.

Further, it is necessary that page numbers are sequential numbers in the linkage in the barcode recognition. Accordingly, it is difficult to perform the linkage with the correct solution page data when the page numbers are not the sequential numbers or when there is a page in which the barcode is not printed such as the multi-form. Besides, it is necessary to consider to deal with a case when the barcode cannot be read resulting from dirt of the form or the blur of the printing.

### SUMMARY OF THE INVENTION

In view of these circumstances, a first object of the present invention is to provide a print inspecting apparatus capable of identifying a page of a form corresponding to a clipped image. A second object of the present invention is to provide a print inspecting apparatus capable of identifying a page of a form corresponding to a clipped image without requiring a special barcode or printing. A third object of the present invention is to provide a print inspecting apparatus capable of identifying a page of a multi-form business form corresponding to a clipped image.

In order to achieve the above-stated objects, the present invention is directed to a print inspecting apparatus that inspects characters printed on a form by a printer, comprising: an acquiring unit which acquires correct solution information representing information on a correct solution of a character string and/or a code printed on the form by the printer, which is associated with a plurality of printing areas in one page on which the character string and/or the code is printed and page information; a conveying unit which conveys the form in one direction; an image reading unit which reads an image on the form being conveyed by the conveying unit; an image clipping unit which clips a plurality of areas from the image read by the image reading unit; a setting unit which sets a plurality of areas to be clipped by the image clipping unit corresponding to the printing areas in advance; a decoding unit which decodes a character string and/or a code in the plurality of areas from the image of the plurality of areas clipped by the image clipping unit; and a page determining unit which determines that the character string in the plurality of areas decoded by the decoding unit falls under that of what page in the form, based on the character string in the plurality of areas decoded by the decoding unit and the correct solution information acquired by the acquiring unit.

In the present invention, the acquiring unit acquires the correct solution information representing the information on the correct solution of the character string and/or the code printed on the form by the printer, which is associated with the plurality of printing areas in one page on which the character string and/or the code is printed and page information, the setting unit sets the plurality of areas to be clipped by the image clipping unit corresponding to the printing areas in advance. Next, the conveying unit conveys the form on which the character string and/or the code is printed by the printer in one direction, the image reading unit reads the images on the form being conveyed by the conveying unit, the image clipping unit clips the plurality of areas from the images read by the image reading unit, and the decoding unit decodes the character strings in the plurality of areas from the images in the plurality of areas clipped by the image clipping unit. The page determining unit determines that the character string in the plurality of areas decoded by the decoding unit falls under that of what page in the form, based on the character strings in the plurality of areas decoded by the decoding unit and the correct solution information acquired by the acquiring unit.

In the present invention, a form in which a mark representing a page is not printed on the form can be used. Besides, a continuous form in addition to a single form may be used as the form. The code includes, for example, a one-dimensional code and a two-dimensional code.

In the present invention, the apparatus may further comprise a uniqueness confirming unit which confirms uniqueness of the character string and/or the code printed on each page relative to all pages of the correct solution information, by combining the character strings of the plurality of printing areas of the correct solution information acquired by the acquiring unit. Besides, the apparatus may further comprise a selecting unit for selecting a uniqueness confirming area of which uniqueness is to be confirmed by the uniqueness confirming unit from among the plurality of areas set by the setting unit in advance. In such an aspect, the uniqueness confirming unit may confirm the uniqueness of each page relative to all pages of the correct solution information based on the uniqueness confirming area selected by the selecting unit. Further, the uniqueness confirming unit may determine whether there is the uniqueness in the character string and/or the code printed on each page relative to all pages of the correct solution information by combining the character strings in the plurality of printing areas of the correct solution information acquired by the acquiring unit, when an affirmative determination is made, may determine whether there is the uniqueness in the character string and/or the code printed on each page even if the number of the uniqueness confirming areas selected by the selecting unit is decreased, when this determination is affirmative, decrease the number of the uniqueness confirming areas when the determination is affirmative, and when a negative determination is made, increase the area which is not selected by the selecting unit among the plural areas set by the setting unit as the uniqueness confirming area in addition to the uniqueness confirming areas selected by the selecting unit.

The image reading unit may read the image by each page on the form being conveyed by the conveying unit, and the image clipping unit may clip the plurality of areas from the image read by the image reading unit by each page. Further, the decoding unit may decode the image of the character string in the plurality of areas clipped by the image clipping unit by clipping one character by one character. At this time, the decoding unit is preferable to have a plurality of computers capable of decoding the image of the character string one character by one character in the plurality of areas clipped by the image clipping unit. The computer may compute a feature amount of each clipped character, or may divide the image of the each clipped character into small areas to use an image forming direction of each small area as an element of the feature amount. The image reading unit may read the images on both faces of the form being conveyed by the conveying unit.

The present invention can take various aspects other than the above aspects and it can achieve various effects corresponding to the aspects. These aspects and effects will be explained below in detail with reference to embodiments.

### BRIEF DESCRIPTION OF THE DRAWINGS

FIG. 1 is an appearance perspective view of a print inspecting apparatus of an embodiment to which the present invention can be applied;

FIG. 2 is a schematic sectional view of a main unit of the print inspecting apparatus;

FIG. 3 is a block diagram illustratively showing functions of a processing unit in the print inspecting apparatus;

FIG. 4 is a block diagram showing a daisy-chain structure between the main unit and the processing unit;

FIG. 5 is an explanatory diagram showing a print example printed on a continuous business form by a system printer;

FIG. 6 is an explanatory diagram of a concept of a first reference position recognition area and a second reference position recognition area to recognize a mark “ [symbol] ” forming a corner of an inspectable area;

FIG. 7 is an explanatory diagram showing a data structure of inspection job data;

FIG. 8 is an explanatory diagram explaining a concept of a position error Δ;

FIG. 9 is an explanatory diagram showing an example of a uniqueness specific area among an inspection area of a continuous business form;

FIG. 10 is a flowchart of a process routine executed by an MCU of the main unit in a print inspection process;

FIG. 11 is a flowchart of a process routine executed by a CPU of an image processing unit in the print inspection process;

FIG. 12 is a flowchart of a process routine executed by an inspecting terminal in the print inspection process;

FIG. 13 is a flowchart of a process routine executed by an inspecting server in the print inspection process;

FIG. 14 is an explanatory diagram showing a print example printed on a multi-form business form by a system printer;

FIG. 15A is a first part of a flowchart of a process routine executed by the inspecting terminal in the print inspection process of the multi-form business form, FIG. 15B is a first part of a flowchart of a process routine executed by the inspecting server in the print inspection process of the multi-form business form, and one flowchart is constituted by FIG. 15A and FIG. 15B; and

FIG. 16 is an explanatory diagram explaining a linkage between a physical page of the multi-form business form and correct solution information by using a barcode.

### DETAILED DESCRIPTION OF THE PREFERRED EMBODIMENTS

An embodiment of a print inspecting apparatus according to the present invention will be explained below with reference to the drawings. Incidentally, in the embodiment, an example where a continuous business form printed by a printer is inspected offline (non-linkage with the print performed by the printer) will be explained.

(Constitution)

As shown in FIG. 1, a print inspecting apparatus 1 of the embodiment is provided with a main unit (reading unit) 10 which reads images printed on a continuous business form F such as a fan-folded paper (folded print papers with feeding holes) by a printer, and a processing unit 30 which makes determination about whether or not characters (including numerals), symbols, a one-dimensional code (e.g., barcode) or a two-dimensional code (e.g., QR code) have been correctly printed on the continuous business form F by the printer. Incidentally, hereinafter, a character, symbol or code is simply called as a “character”, however, the code may be referred to, in a case of necessity.

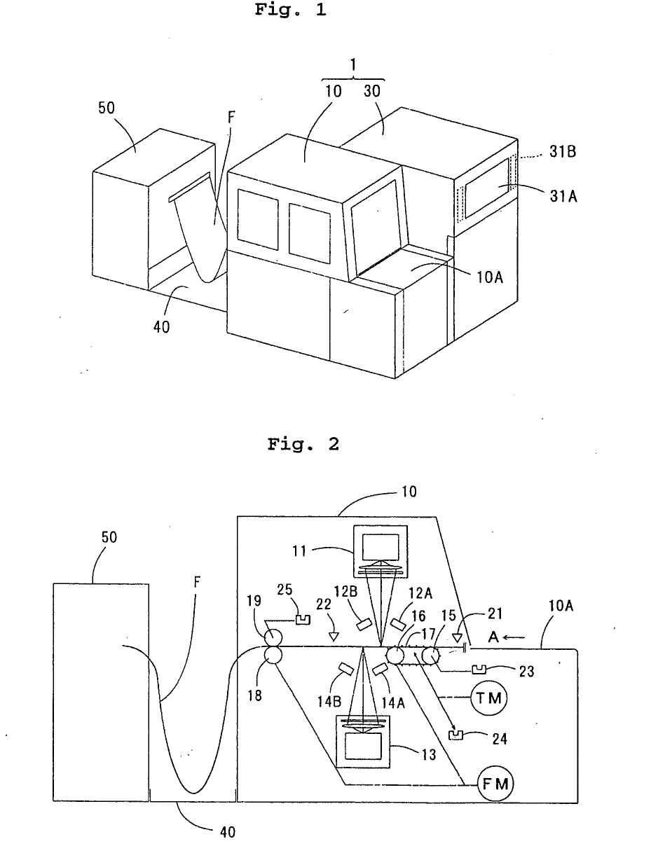

As shown in FIG. 2, the main unit 10 has two tractor belts 17 which are formed with a plurality of projections engaged with feeding holes formed on both sides of the continuous business form F to convey the continuous business form F in one direction (in a direction of arrow A in FIG. 2) inside a casing having an approximately horizontal conveying face 10A. The tractor belts 17 are spanned between tractor rollers 15 and 16. Incidentally, the main unit 10 has a tractor width adjusting motor TM for adjusting a tractor width between the two tractor belts 17 in order to match with a width size of the continuous business form F.

On the other hand, conveying and discharging rollers 18 and 19 which covey the continuous business form F in one direction (in the direction of arrow A in FIG. 2) in cooperation with the tractor belts 17 and discharge the continuous business form F outside the main unit 10 are disposed in the vicinity of a discharge port (not shown) of the casing. The tractor roller 16 and the conveying and discharging roller 18 are driving rollers, and are transmitted with rotational driving forces from a conveying motor FM constituted by a stepping motor via a not-shown driving force transmission mechanism constituted by a plurality of gears. Incidentally, such a structure that the conveying and discharging roller 19 can be moved between two positions where it separates from the conveying and discharging roller 18 and contacts with the roller 18 is taken for the conveying and discharging rollers 18 and 19 in order to allow setting of the continuous business form F in between the conveying and discharging rollers 18 and 19.

An upper face of the tractor belt 17 spanned between the tractor rollers 15 and 16 and a contacting point between the conveying and discharging rollers 18 and 19 are set to be approximately the same height level with each other. Therefore, the continuous business form F is guided into the casing of the main unit 10 approximately horizontally in a state that a back face thereof sliding-contacts with the conveying face 10A and the continuous business form F is pulled between the conveying and discharging rollers 18 and 19 and the tractor belts 17 with a constant force so that it is conveyed in its approximately horizontal state to be discharged outside the casing by the conveying and discharging rollers 18 and 19. Incidentally, in the embodiment, the maximum conveying speed of the continuous business form F is set to approximately 1.5 m/s.

A surface line scan camera 11 reading an image printed on a surface of the continuous business form F is disposed above the tractor belt 17 on a downstream side thereof (at left side in FIG. 2) and a back face line scan camera 13 reading an image printed on a back face of the continuous business form F is disposed below the tractor belt 17 on a slightly downstream side of the surface line scan camera 11. The line scan cameras 11 and 13 are each constituted by a dichroic filter, a lens, and a CCD line sensor in the casing.

White light LED arrays 12A, 12B, and 14A, 14B for illuminating reading positions of the line scan cameras 11 and 13 are each disposed on both sides of the reading positions. Incidentally, rod lenses (not shown) for condensing white lights in a line shape relative to the reading positions are each disposed in the vicinity of the LED arrays 12A, 12B, and 14A, 14B.

An original set detecting sensor 21 detecting whether or not the continuous business form F has been set at the main unit 10 which is disposed above the tractor belt 17 on an upstream side thereof, a remaining paper detecting sensor 22 detecting whether or not the continuous business form F remains between the tractor belt 17 and the conveying and discharging rollers 18 and 19, a rotary encoder 23 which is attached to a rotation shaft of the tractor roller 15 to detect a conveying amount of the tractor belt 17 relative to the continuous business form F, a tractor width home position detecting sensor 24 attached in the vicinity of a gear (not shown) adjusting a tractor width between two tractor belts 17 to detect a home position of the tractor width, and a jamming detecting sensor 25 which is attached to the rotation shaft of the conveying and discharging roller 19 detecting jamming of the continuous business form F are each disposed in the main unit 10.

The main unit 10 has a power source unit (not shown) which converts a commercial alternating current power source to a direct current power source which can drive/activate a drive unit or the like and a microcomputer (not shown, hereinafter called as an MCU for short) which performs operation control on the whole main unit 10. The MCU is connected with a sensor control unit controlling the above-described sensors, an actuator control unit controlling motor drives, an image processing unit having a CPU, clipping an image for one page read by the line scan camera, and an interface performing communication with the processing unit 30, via an external bus.

A plurality of opening doors for setting the continuous business form F and for maintenance and repair are provided at the casing of the main unit 10. A folding apparatus 50 folding the continuous business form F and a loop stand 40 serving as a buffer adjusting a folding rate of the folding apparatus 50 and a conveying speed of the continuous business form F of the main unit 10 are disposed on a downstream side of the main unit 10 in the order of the loop stand 40 and the folding apparatus 50.

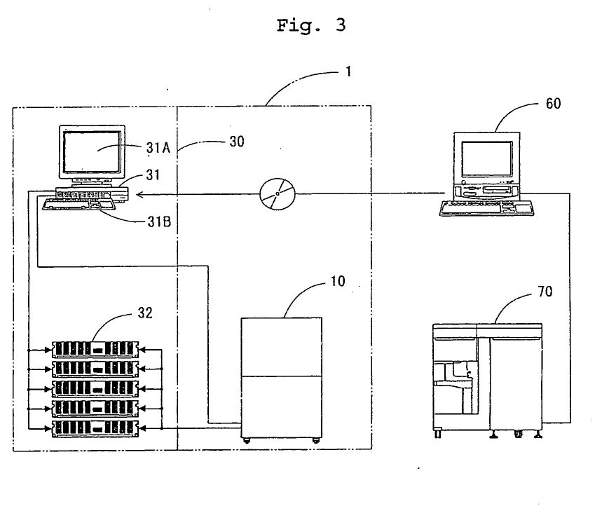

As shown in FIG. 1 and FIG. 3, the processing unit 30 is constituted by an inspection server 31 disposed inside the casing and inspecting terminals 32 (32A, 32B, 32C, 32D, and 32E) composed of a plurality of computers with the same specification. In other words, as shown in FIG. 1, when the processing unit 30 is considered mechanically, it is a lack accommodating the inspection server 31 and the inspecting terminals 32 and when it is considered functionally, as shown in FIG. 3, it is a computer group determining whether or not characters have been correctly printed on the continuous business form F by the printer. Incidentally, FIG. 3 is an equivalent block diagram of FIG. 1 mainly representing the functional aspect by each computer.

As shown in FIG. 1, a display 31A of the inspection server 31 is disposed on an upper portion of the processing unit 30, and a plurality of operation buttons 31B (corresponding to a keyboard of the inspection server 31 shown in FIG. 3) are disposed on both sides of the display 31A. The inspecting terminals 32 are disposed at a lower portion of the inspection server 31. As shown in FIG. 3, the inspection server 31, the respective inspecting terminals 32, and the main unit 10 are connected to one another via communication lines.

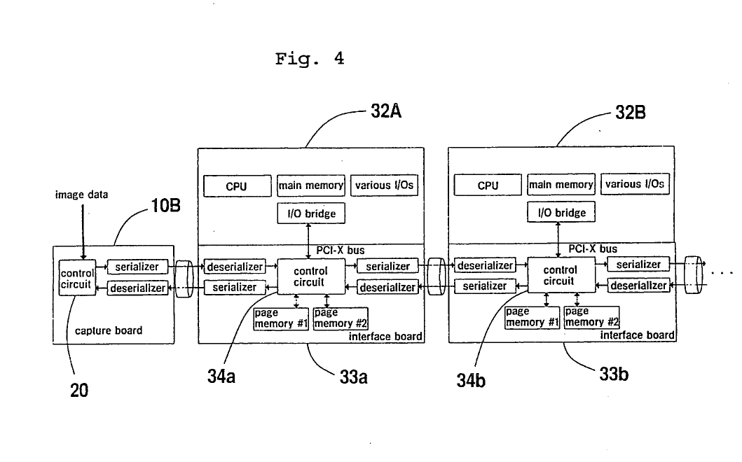

As shown in FIG. 4, the interface of the main unit 10 has a capture board 10B having a control circuit 20, a serializer, and a deserializer. On the other hand, an interface board 33 (33a, 33b, 33c, 33d and 33e) having a control circuit 34 (34a, 34b, 34c, 34d and 34e), a serializer, a deserializer, and a page memory capable of storing image data of pages are disposed in each inspection terminal 32. The capture board 10B of the main unit 10 and the interface board of each inspection terminal 32 are connected with each other via a communication line in a daisy-chain manner where the capture board 10B is positioned at the most upstream side. Therefore, the main unit 10 can transmit image data and the like to the inspection terminal 32 in a standby state.

(Continuous Form)

Next, the continuous business form F to be inspected by the print inspecting apparatus 1 of the embodiment will be explained. Incidentally, as shown in FIG. 3, the continuous business form F will be explained as the one printed by a system printer 70 controlled by a print server 60 for simplification in explanation.

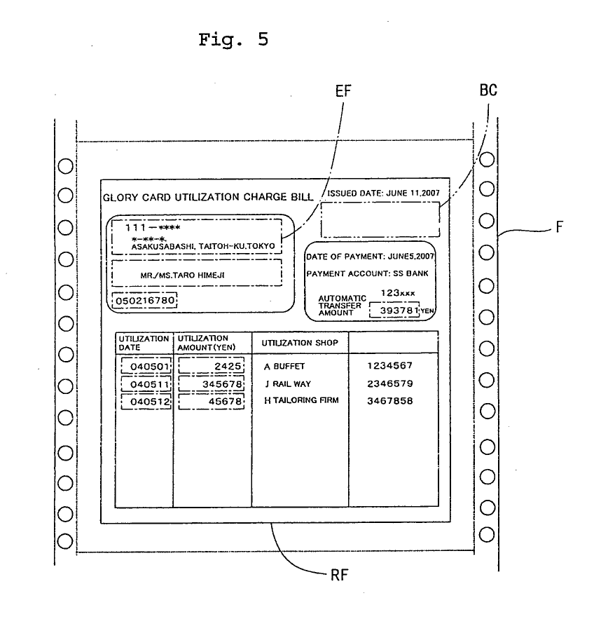

FIG. 5 illustratively shows an example where the continuous business form F shown in FIG. 5 is used as an account statement. A character string constituting contents of the account statement is printed on the continuous business form F by the system printer 70. In the embodiment, characters in an inspection area EF shown by a one-dotted chain line in FIG. 5 are inspection target characters inspected by the print inspecting apparatus 1. Besides, in the example shown in FIG. 5, a barcode area BC where a one-dimensional or two-dimensional barcode is printed is also set inside an inspectable area RF, and the inspection target may be such barcode. Incidentally, in the embodiment, similar marks and barcodes are printed on a back face of the continuous business form F, and the inspection area EF can be set in an area different from a surface side.

A point to be focused here is that a start mark representing a start of each page, an end mark representing an end of each page enabling the main unit 10 to read the image of the continuous business form F in a page unit, a barcode in which page information relative to the continuous business form F by the system printer 70 is coded, and so on are not printed in each page of the continuous business form F, compared to the above-stated technology in the Patent Document 1.

(Operation)

Next, an operation of the print inspecting apparatus 1 according to the embodiment will be explained in the order of a dictionary creation process, a form registration process, and a print inspection process. The dictionary creation process and the form registration process are performed before the print inspection process of the continuous business form F is performed by the print inspecting apparatus 1.

<Dictionary Creation Process>

The dictionary creation process is a process computing respective feature amounts of characters to be printed on the continuous business form F by the system printer 70 to prepare a dictionary defining correspondence between the computed feature amounts and the characters (information). Details are as described below.

First, the print server 60 causes the system printer 70 to print a character string on a dedicated continuous business form for preparing dictionary (hereinafter, called as a continuous form for dictionary preparation) in a predetermined form at corresponding to character information including codes, fonts, and font sizes of all characters to be printed on the continuous business form F. In the embodiment, a continuous business form which is approximately plain and on which no predetermined character is printed in advance, which is different from the continuous business form F shown in FIG. 5, and which has the same paper quality as that of the continuous business form F is used as the continuous form for dictionary preparation. As the predetermined format, a format where an identification mark indicating that a character for dictionary preparation is printed on each row, a reference character indicating a size of one character, and characters with plurality font sizes by each font are printed and two or more characters are printed for one font size is used. The “predetermined format” means a protocol where aspect of all characters constituting character information printed on the continuous form for dictionary preparation by the system printer 70 can also be grasped on the side of the processing unit 30.

Next, the character information including codes, fonts, font sizes of all characters to be printed on the continuous form for dictionary preparation by the system printer 70 is written into a recording medium by the print server 60 so as to fit the above-described predetermined format, and the character information is inputted to the inspection server 31 via the recording medium. The inspection server 31 transmits the character information to each inspection terminal 32, and each inspection terminal 32 stores the character information to a hard disk. Thereby, the preparation for dictionary creation process is completed. In general, since fonts and font sizes of characters printed on the continuous business form F utilized as account statements or debit notes are restrictive, amount of information recorded on the recording medium by the print server 60 is not so increased. Accordingly, the above-described “all characters to be printed” does not mean all characters which can be printed by the system printer 70, but it means removal of characters with fonts and font sizes which are not printed on the continuous business form F. When the recording medium has an allowance, all characters which can be printed by the system printer 70 may be recorded on the recording medium.

When an operator sets the continuous form for dictionary preparation printed by the system printer 70 to the main unit 10 and presses a predetermined button (a pre-feed button) among the operation buttons 31B, the print inspecting apparatus 1 starts a pre-feeding to convey the continuous form for dictionary preparation for a predetermined distance.

Namely, the MCU of the main unit 10 receiving a command of the pre-feeding from the processing unit 30 (the inspection server 31) turns on the LED arrays 12A, 12B and 14A, 14B, and drives the conveying motor FM via the actuator control unit. The continuous form for dictionary preparation is thereby conveyed in the direction of arrow A in FIG. 2 at a constant speed, and the line scan cameras 11, 13 start image reading of the continuous form for dictionary preparation. Besides, the MCU starts a monitoring of jam and so on of the continuous form for dictionary preparation with reference to a signal from the sensor control unit.

(The CPU of) the image processing unit of the main unit 10 determines whether or not a tip portion of the continuous form for dictionary preparation is conveyed up to a reading position by monitoring an output from the surface line scan camera 11. When the determination is affirmative, the image processing unit informs the MCU of the main unit 10 of the state, and when the determination is negative, the determination whether or not the tip portion of the continuous form for dictionary preparation is conveyed up to the reading position is continued. The MCU of the main unit 10 informed of the above further drives the conveying motor FM for the predetermined number of pulses via the actuator control unit, and thereafter, stops the driving of the conveying motor FM.

Accordingly, the tip portion of the continuous form for dictionary preparation is conveyed (being pre-fed) for a predetermined distance (for example, 3 m) from the reading position of the surface line scan camera 11. The operator sets the tip portion of continuous form for dictionary preparation at the folding apparatus 50 after the pre-feed convey of the continuous form for dictionary preparation is finished (after the tip portion of the continuous form for dictionary preparation is discharged from the main unit 10 to the loop stand 40, and stopped). Next, when a predetermined button (a dictionary creation process button) among the operation buttons 31B is pressed by the operator, the MCU of the main unit 10 drives the conveying motor FM again, and the print inspecting apparatus 1 starts the dictionary creation process. Incidentally, the MCU of the main unit 10 also informs (the CPU of) the image processing unit of the number of conveying pulses outputted to the conveying motor FM via the actuator control unit.

(The CPU of) the image processing unit of the main unit 10 clips an image for one page at a rough position owing to a conveying amount management of the conveying motor FM (in this example, by counting the number of conveying pulses outputted from the actuator control unit while using the position of the tip portion of the continuous business form F as a reference), supplies the clipped image with a sequential image index (for example, an image number), and outputs the clipped image data for one page and the image index to the control circuit 20 of the capture board 10B.

On the other hand, the control circuit 34 of the interface board 33 of each inspection terminal 32 performs a predetermined response and a preparation of report including status information indicating an operation state of each inspection terminal 32 for the control circuit 20 of the capture board 10B of the main unit 10. The response is a status report showing a result obtained by execution of a command for initialization, image data transfer, or the like issued for the interface board 33 of each inspection terminal 32 by the capture board 10B, and the report is a report autonomously prepared by the control circuit 34 every time when the operation states of each inspection terminal 32 changes, such as termination of the page memory utilization. The response and report are transmitted to the capture board 10B from the interface board of a downstream side inspecting terminal toward the interface board of an upstream side inspecting terminal, and (a control circuit of) an interface board of an intermediate (an upstream side) inspecting terminal transfers the response and report transmitted from the downstream side interface board to a further upstream side interface board or the capture board 10B such that the capture board 10B can receive the response and report.

Therefore, the control circuit 20 of the capture board 10B can grasp the operation state of each inspection terminal 32 by the response and report form the interface board 33 of each inspection terminal 32. Accordingly, the capture board 10B determines a destination (an awaiting inspecting terminal) based upon predetermined conditions each time when either one of the inspecting terminals 32 is in a receivable state of image data for one page and the like (image data for one page, image index) to transmit image data for one page and the like outputted from the image processing unit to the interface board of the determined inspecting terminal. That is, a unique number allocated to the inspecting terminal is designated and image data for one page and the like is transmitted at a time of transmission from the capture board 10B to the interface board 33 of each inspecting terminal. The control circuit 34 of the interface board 33 of each inspection terminal 32 determines whether or not the designated unique number coincides with the own number. When the determination is affirmative, the control circuit 34 takes in the image data for one page and the like, and when the determination is negative, the control circuit 34 transfers the received image data for one page and the like to a downstream side interface board.

In the embodiment, the above-described predetermined conditions are as stated below. The capture board 10B determines to transmit image data and the like to the n-th inspecting terminal, (1) when the first to the (n−1)th inspecting terminals are all in operation using the first page of the page memory, and the n-th inspecting terminal is not in operation using the first page of the page memory, or (2) when all the inspecting terminals are in operation using the first page of the page memory, the first to the (n−1)th inspecting terminals are in operation using the second page of the page memory, and the n-th inspecting terminal is not in operation using the second page of the page memory.

Each inspection terminal 32 at first performs a blank check determining whether the image of the received image data for one page is blank or a page where characters and so on are printed. Namely, the page is determined to be the page where the characters and so on are printed when a rate of black is equal to or more than a predetermined value (when the rate of black is equal to or more than a rate of black generated by dirt or dust) of an image area for one page or a predetermined area (for example, the inspection area of a customer addresses in FIG. 5) among the image area for one page. The corresponding page is determined to be blank when the rate of black is less than the predetermined value. Each inspection terminal 32 waits until the next image data for one page is transmitted because it is not necessary to perform the process for the page, when the page is determined to be blank.

On the other hand, when the page is determined to be the page where the characters and so on are printed, each inspection terminal 32 further determines whether or not the page is the image data of the first page which is not blank transmitted to the inspecting terminal. When the determination is negative, each inspection terminal 32 performs a later-described character image clipping, and when the determination is affirmative, each inspection terminal 32 informs the inspection server 31 of the image index corresponding to the image data of the first page which is not blank transmitted to the inspecting terminal. The inspection server 31 grasps a correspondence between the first page of the continuous form for dictionary preparation (the first page where the characters and so on are actually printed) and the image index by referring to reports (the image index corresponding to the first page which is not blank) from all of the inspecting terminals 32, and informs each inspection terminal 32 of the grasped correspondence. Each inspection terminal 32 is thereby able to know the correspondence between a physical page of the continuous form for dictionary preparation of which feature amount is computed and the image index. Incidentally, the image indexes are sequential, and therefore, it is possible for each inspection terminal 32 to grasp which page is being processed from the image index if the correspondence between the image index and the physical page of the continuous form for dictionary preparation is once known.

When the page is determined to be the page where the characters and so on are printed, each inspection terminal 32 clips the character image one character by one character from the image of the received image data for one page, supplies a sequential character image index (for example, a character image number) to the clipped character image, and stores the image data of the clipped character image, the character image index and the above-stated image index to a hard disk.

Incidentally, it is not necessary to use the character image index, but character information stored in the hard disk can be used as an index, when the inspection server 31 informs each inspection terminal 32 of the correspondence between the physical page of the continuous form for dictionary preparation and the image index before the clipping of the character image is started. However, the inspection server 31 does not always inform each inspecting terminal of the correspondence between the physical page of the continuous form for dictionary preparation and the image index before the clipping of the character image depending on process timing. Accordingly, each inspection terminal 32 tentatively supplies the character image index to the image data of the clipped image, brings the character image index into correspondence with the character information at the time when the inspection server 31 informs each inspection terminal 32 of the correspondence between the physical page of the continuous form for dictionary preparation and the image index, and after that, uses the character information as the index.

Next, each inspection terminal 32 reads the clipped character image and the character image index (or the character information) from the hard disk one character by one character. Each inspection terminal 32 then computes feature amounts obtained by, for example, dividing the clipped character image into small areas of 5×5, computing feature vectors about slopes of respective small areas in an image forming direction when eight directions (45 degrees) are defined as reference vectors, and multiplying the respective feature vectors by weight coefficients. Incidentally, when the image is divided into the small areas of 5×5 and the reference vectors in the eight directions are used, 200 feature spaces are formed for each one character, and the weight coefficients can be set, for example, such that a feature vector of a small area constituting an outer side of a character becomes large. In the embodiment, since two or more characters are printed for the same character (characters identical in code, font, and font size) on the continuous form for dictionary preparation, each inspection terminal 32 brings the character image index into correspondence with the character information, to compute an average feature amount as for the same character, for example, after the characters for one page are clipped and before the computation of the feature amounts of the respective clipped characters are started. When each inspection terminal 32 computes feature amounts of the characters for the received one page, it associates the character information, the feature amount, and the image data of character one character by one character by using the character information as index (prepare the dictionary for one page) to transmit them to the inspection server 31 together with the image index.

The inspection server 31 receives the dictionaries prepared by at least one or more inspecting terminal (s) 32 to reconstruct a plurality of dictionaries prepared by the inspecting terminals into one dictionary. The dictionary has a data structure capable of having a plurality of additional feature amounts (described later) added as the feature amount. Next, the inspection server 31 refers to the image index received from the inspecting terminals 32 to determine whether or not the correspondence among the character information, the feature amounts, and the image data has been defined regarding all characters constituting the character information inputted via the recording medium (the dictionary for all characters has been prepared). When the determination is negative, the inspection server 31 further transmits the image data for one page, print process information, and the character information corresponding to the page to the inspection terminal 32 in a standby state (which has transmitted the feature amount and the like to the inspection server 31) in order to prepare the remaining portion of the dictionary. When the determination is affirmative, the inspection server 31 causes each inspection terminal 32 to verify the prepared dictionary.

That is, the inspection server 31 transmits the character information, the feature amounts, and the image data, and resolution information of a resolution lower than that of the image of the image data for several tens characters to each inspection terminal 32 from among the prepared dictionary. Each inspection terminal 32 generates an image with a resolution reduced according to the resolution information from the received image data to compute feature amounts obtained by dividing the generated image into the above-described small areas, computing feature vectors about slopes of respective small areas in an image forming direction when eight directions are defined as reference vectors, and multiplying the respective feature vectors by weight coefficients. Next, the inspection server 31 determines whether or not the computed feature amount is equal to or more than a verification reference value which is set in advance for the received feature amount. When the determination is affirmative, information indicating that the feature amount of the character to be verified is proper is added to the character information. When the determination is negative, information indicating that the feature amount of the character to be verified is improper is added to the character information. When a process for the several tens characters has been terminated, the character information is transmitted to the inspection server 31.

The inspection server 31 determines whether or not the character information regarding all characters in the prepared dictionary are received. When the determination is negative, the inspection server 31 further transmits the character information, the feature amounts, the image data, and the resolution information for several tens characters to the inspection terminal 32 in a standby state. When the determination is affirmative, the inspection server 31 refers to the information added to each character information to determine whether or not a character whose feature amount has been determined to be improper exists. When it is determined that the character whose feature amount has been determined to be improper does not exist, the inspection server 31 gives a dictionary name to the prepared dictionary to store contents of the prepared dictionary (defining the correspondence among character information, feature amounts, and image data) to a hard disk and transmits information about the dictionary and the dictionary name except the information about the correspondence between the character information and the image data in the prepared dictionary to each inspection terminal 32, thereby terminating the dictionary creation process. When it is determined that the character whose feature amount has been determined to be improper exists, the inspection server 31 causes the inspection terminal 32 to change (lower) the verification reference value as for the character and continues this step until the feature amounts of all the characters in the prepared dictionary are determined to be proper, sets the (changed) verification reference value as a determination reference value described later (changes a default value of the determination reference value preliminarily set as accompanying information for the dictionary), gives a dictionary name to the prepared dictionary to store contents of the prepared dictionary to the hard disk and transmits information of the dictionary and the dictionary name except the information about the correspondence between the character information and the image data in the prepared dictionary to each inspection terminal 32, thereby terminating the dictionary creation process. Each inspection terminal 32 stores the received information of the dictionary and the dictionary name to its hard disk.

<Form Registration Process>

Next, the form registration process will be explained. The form registration process is a process for setting the inspection area to be the inspection target whether characters are printed properly, a reference position recognition area to be a reference to clip the inspection area, a uniqueness specific area to grasp a page of a clipped image by using uniqueness of a character string printed on a specific area among the inspection area, and a barcode area to which a one-dimensional or two-dimensional barcode is printed, and details thereof are as stated below.

[Setting of Reference Position Recognition Area]

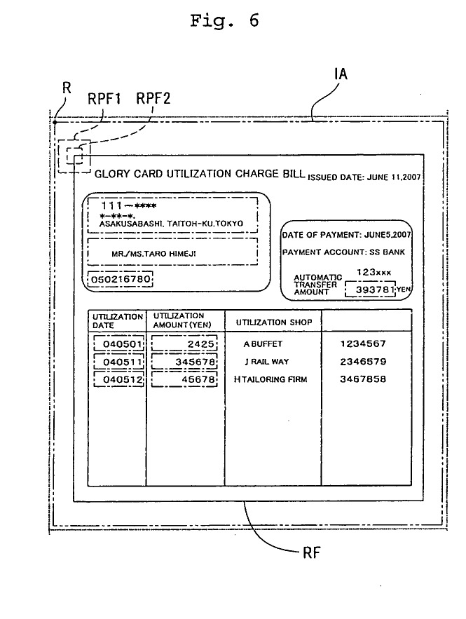

The CPU of the image processing unit outputs the image data for one page of the continuous business form F read by the main unit 10 according to the above-stated conveying amount management, to the control circuit 20 of the capture board 10B. Here, the setting of the reference position recognition area is described with reference to FIG. 6. As shown in FIG. 6, an image area for one page clipped by the conveying amount management is set as IA. For example, a relationship between a reference coordinate position R (0, 0) of the image area IA and a coordinate position (X, Y) of a mark (a part of a ruled line) “ [symbol] ” (hereinafter, referred to as the mark “ [symbol] ”) forming a corner of the inspectable area RF is set by the setting of the reference position recognition area. When the image is clipped according to the conveying amount management, loosening is easy to occur on the continuous business form F because the tip portion of the continuous business form F is not held by pins of the tractor belts 17. As a result, inconsistency occurs between the continuous business form F and the conveying amount for the degree of loosening (the inconsistency occurs in each page). Accordingly, a first reference position recognition area RPF1 in approximately square centering on the mark “ [symbol] ”, and a second reference position recognition area RPF2 smaller than the first reference position recognition area RPF1 are set. Specifically, the operator presses a predetermined button (a reference position setting button) from among the operation buttons 31B, and thereby, the image data for one page and an input box to input a position are displayed on the display 31. The operator then specifies the mark “F” forming the corner of the inspectable area RF, and sequentially inputs the reference coordinate position R (0, 0), the coordinate position (X, Y) of the mark “ [symbol] ”, and sizes (coordinate positions) of the first reference position recognition area RPF1 and the second reference position recognition area RPF2 to the input box. Incidentally, the relationship between the reference coordinate position R (0, 0) and the coordinate position (X, Y) of the mark “ [symbol] ” forming the corner of the inspectable area RF is already known at the manufacturing time of the continuous business form F (in the present example, the position of the reference coordinate position R is set to be a position of 3 mm from a perforation forming a boundary of one page of the continuous business form in both X direction and Y direction while considering a conveying amount error). The size of the first reference position recognition area RPF1 is set in advance so that the inconsistency for the degree of the loosening can be absorbed (displayed on the display 31), and the operator sets the first reference position recognition area RPF1 to be the size larger than the displayed size.

The control circuit 20 of the capture board 10B outputs the image data for one page of the continuous business form F read by the main unit 10 to an arbitrary inspection terminal 32 as stated above. On the other hand, the inspection server 31 acquires pattern information of the mark “ [symbol] ” forming the corner of the inspectable area RF from the inspection terminal 32. The inspection server 31 thereby grasps the reference coordinate position R (0, 0), the pattern information of the mark “ [symbol] ” forming the corner of the inspectable area RF, the coordinate position (X, Y) of the mark “ [symbol] ”, and the coordinates of the first reference position recognition area RPF1 and the second reference position recognition area RPF2.

[Setting of Inspection Area]

The inspection server 31 clips an image so as to include the inspectable area RF (refer to FIG. 5) based upon the coordinate position (X, Y) of the mark “ [symbol] ” forming the corner of the inspectable area RF to perform magnification correction and displays the clipped image on the display 31A to wait for designation of the inspectable area RF and the inspection area EF performed by the operator. The operator sequentially designates the inspection area EF after the inspectable area RF is designated through the operation button 31B (or an external computer logged in the inspection server 31) so that the inspection server 31 acquires positional information of the inspectable area RF and the inspection area EF as the coordinate position (X, Y) of the mark “ [symbol] ”.

The inspection server 31 determines whether or not an operation button indicating that the designation of the inspection area EF is terminated is pressed (or a command for terminating the designation has been received from the external computer). When the determination is negative, the inspection server 31 waits ready because the inspection area EF may be designated continuously. When the determination is affirmative, the inspection server 31 stores the acquired positional information of the inspectable area RF and the inspection area EF to the hard disk.

[Setting of Uniqueness Specific Area]

The inspection server 31 calculates sizes (areas) of the designated inspection areas EF after the designation of the inspection areas EF is performed, and for example, prepares a list of the inspection areas EF in ascending order in areas. Next, the inspection server 31 performs the magnification correction of the image including the inspectable area RF as same as in case of the inspection area setting to display on the display 31A, and waits until the operator specifies the uniqueness specific area. The operator specifies at least one uniqueness specific area from among the inspection areas EF by the operation button 31B (or the external computer logged in the inspection server 31), and the inspection server 31 acquires information of the specified uniqueness specific area from among the inspection areas EF. As the uniqueness specific area, for example, it is possible to select an area of a customer code (“050216780” in FIG. 5) which is easy to secure the uniqueness.

The inspection server 31 determines whether or not an operation button indicating a termination of the specification of the uniqueness specific area is pressed (or a command for terminating the specification has been received from the external computer). When the determination is negative, the inspection server 31 waits ready because the uniqueness specific area may be specified continuously. When the determination is affirmative, the inspection server 31 stores the list of the inspection areas EF in ascending order in areas and the information of the specified uniqueness specific area to the hard disk.

[Setting of Barcode Area]

The inspection server 31 performs the magnification correction of the image including the inspectable area RF as same as in case of the inspection area setting to display on the display 31A, and waits until the operator designates a barcode area BC. The operator designates the barcode area BC through the operation button 31B (or the external computer logged in the inspection server 31), and the inspection server 31 acquires positional information of the barcode area BC as the coordinate position (X, Y) of the mark “ [symbol] ”

The inspection server 31 determines whether or not an operation button indicating a termination of the designation of the barcode area BC is pressed (or a command for terminating the designation has been received from the external computer). When the determination is negative, the inspection server 31 waits ready because the barcode area BC may be designated continuously. When the determination is affirmative, the inspection server 31 stores the positional information of the barcode area BC to the hard disk. Incidentally, in the above description, the example is shown in which the setting of the inspection area, the setting of the uniqueness specific area, and the setting of the barcode area are performed sequentially for simplification in explanation, but these settings may be performed in bulk (all at once).

[Registration Form Information]

The inspection server 31 supplies the continuous business form F to which the inspection area EF and so on are designated with a registration form name, and stores the clipped image data of the continuous business form F, the feature amount of the mark “ [symbol] ” forming the corner of the inspectable area RF, the positional information (X, Y) of the mark “ [symbol] ” relative to the reference coordinate position R, the positional information of the first reference position recognition area RPF1 and the second reference position recognition area RPF2, the positional information of the inspectable area RF and the inspection area EF, the information regarding the uniqueness specific area specified from among the inspection areas EF, the positional information of the barcode area, and the list of the inspection areas EF in ascending order in areas to the hard disk, while establishing associations with the registration form name (hereinafter, this information is called as registration form information).

Names which can be easily identified by the operator can be attached to the above-described registration form name. For example, the operator can display the inspection area EF and the like on the display 31A by operating the operation button 31B (or logging in the inspection server 31 from the external computer, it is the same in the following operations) to designate the name attached to the registration form name. FIG. 5 shows an example where ten inspection areas EF and one barcode area BC have been designated.

### <Print Inspection Process>

### [Inspection Job Data]

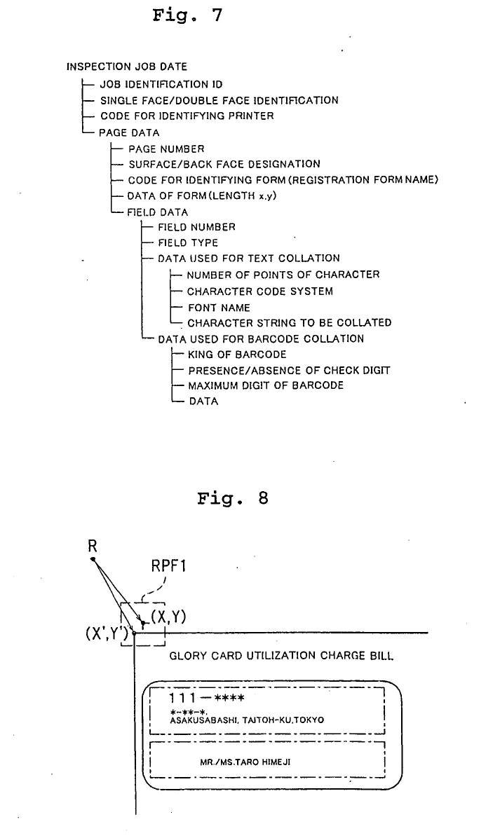

Next, a print inspection process will be explained. Prior to the print inspection process, the print server 60 outputs print data to the system printer 70 to cause the system printer 70 to print a character string desired by the operator on the continuous business form F and prepares inspection job data (correct solution information) based upon the print data outputted to the system printer 70 to output the same to a recording medium. FIG. 7 shows an example of a data structure of the inspection job data. The inspection job data includes data of the continuous business form F (width, length of one page), a job for the continuous business form F performed by the system printer 70 and information to specify each page or the above-described character information, in addition to the information (code to identify a printer, a code to identify a form) to specify the dictionary name and the registration form information (registration form name).

The operator operates the operation button 31B to cause the inspection server 31 to read the inspection job data recorded on the recording medium prepared by the print server 60 (steps 402 and 404 in FIG. 13). When the inspection server 31 reads the inspection job data, it stores the read inspection job data to the hard disk.

[Securing of Page Uniqueness by Uniqueness Specific Area]

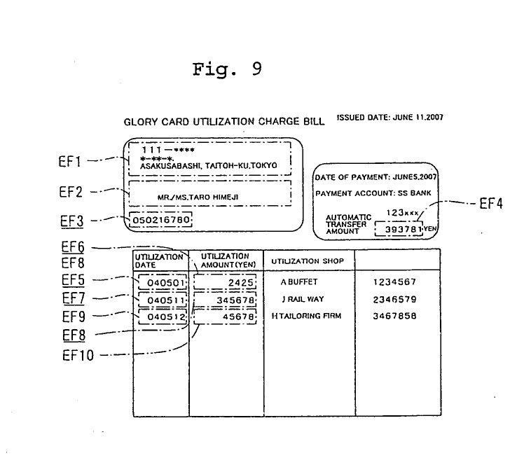

Next, the inspection server 31 specifies a field number of a corresponding area (refer to FIG. 7) in the inspection job data stored in the hard disk by the positional information of the uniqueness specific area from among the registration form information stored in the hard disk, to determine whether or not there is a data matching (the same) with the data in the field number in a page unit. For example, when the customer code is specified as the uniqueness specific area, a page of the clipped image can be recognized by referring to a page number (refer to FIG. 7) corresponding to the customer code in the inspection job data if the matching data does not exist. However, for example, the same customer code is printed on different pages when a plurality of account statements are issued for the same customer, and therefore, the page cannot be identified. In general, other uniqueness specific areas are therefore specified in addition to the customer code in the above-stated setting process of the uniqueness specific area. FIG. 9 shows an example in which an inspection area EF3 showing the customer code, inspection areas EF5, EF7 showing utilization date, and inspection areas EF6, EF8 showing utilization amount to which underlines are added are specified as the uniqueness specific areas from among the inspecting areas. On the other hand, a process time increases if the number of the uniqueness specific areas increases though the securing of the uniqueness in a page unit is enabled.

Accordingly, the inspection server 31 at first determines whether or not there is uniqueness in a page unit in a combination of the character strings (data) in a plurality of field numbers corresponding to the uniqueness specific areas in step 406. For example, in the example in FIG. 9, the inspection areas EF5 to EF8 are specified as the uniqueness specific areas in addition to the inspection area EF3 showing the customer code, and therefore, it is possible to identify the page from the other pages having the same customer code (the uniqueness can be secured in a page unit) owing to the combination of the inspection areas EF3, EF5 to EF8 even when the same customer code is printed on a different page (if the uniqueness cannot be secured by the character string in an area unit). When the determination is negative, the inspection server 31 displays a message on the display 31A indicating that the uniqueness of the page cannot be secured by the specified uniqueness specific areas. At the same time, the inspection server 31 repeats the determination until the uniqueness is secured in a page unit by specifying the field number in the inspection job data one by one to increase the number of the field numbers (for example, the field number in the inspection job data corresponding to an inspection area EF9 is increased when the inspection area EF9 is added to the uniqueness specific area) while including a character string (data) in the increased field number, in the ascending order in areas of the inspection areas EF other than the uniqueness specific areas (when a plurality of inspection areas EF having the same areas exist as shown in FIG. 9, for example, in an ascending order of the inspection areas EF in number) while referring to the list of the inspection areas EF in ascending order in area. The inspection server 31 displays a message on the display 31A indicating that the uniqueness specific area is added, stores updated registration form information (hereinafter, referred to as updated registration form information) to the hard disk by adding information relating to the uniqueness specific area corresponding to the added field number to the information relating to the uniqueness specific area of the registration form information, and deleting the list of the inspection areas EF in ascending order in areas. On the other hand, when determination is affirmative, the inspection server 31 determines whether or not the securing of the uniqueness in a page unit is possible even if the number of the uniqueness specific areas (field numbers) is further decreased (for example, the inspection areas EF6, EF8 in FIG. 9 are decreased as the uniqueness specific areas). When the determination is negative (when the uniqueness cannot be secured), the updated registration form information in which the list of the inspection areas EF in ascending order in areas is deleted from the registration form information, is stored to the hard disk. When the determination is affirmative (when the uniqueness can be secured), the updated registration form information in which the information relating to the uniqueness specific area corresponding to the decreased field number is deleted from the information of the uniqueness specific area of the registration form information (for example, the inspection area EF8 is not treated as the uniqueness specific area), and the list of the inspection areas EF in ascending order in areas is deleted, is stored to the hard disk.

Next, the inspection server 31 transmits the inspection job data and the updated registration form information to each inspection terminal 32 (step 408). Each inspection terminal 32 receives and stores the inspection job data and so on to the hard disk when the inspection job data and so on is transmitted (steps 302, 304 in FIG. 12). Preparation of the print inspection process at the processing unit 30 (the inspection server 31 and each inspection terminal 32) side is thereby completed.

When the operator sets the continuous business form F printed by the system printer 70 to the main unit 10 and presses a pre-feed button among the operation buttons 31B (step 410 in FIG. 13), the inspection server 31 transmits a pre-feed command to the MCU of the main unit 10 (step 412).

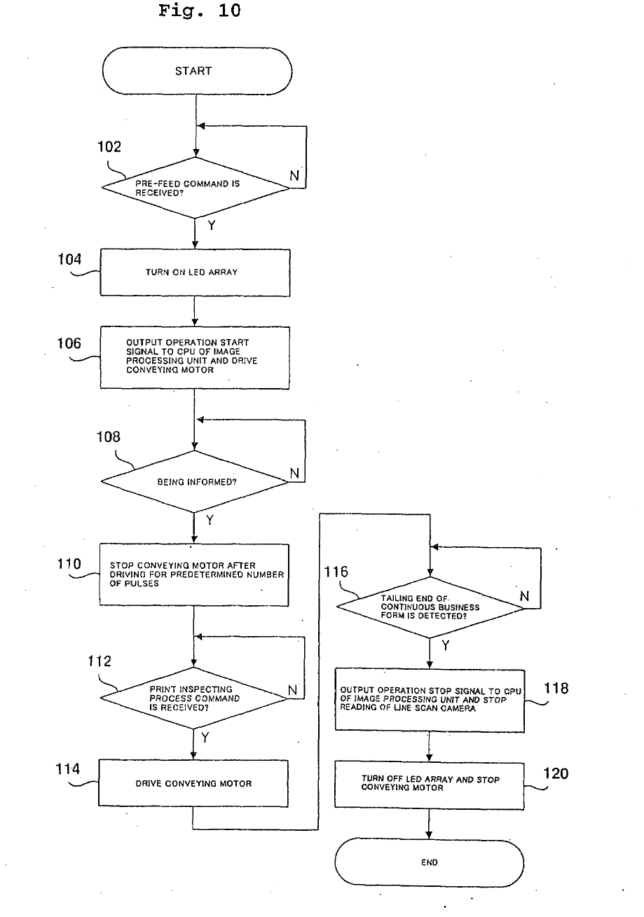

The MCU of the main unit 10 which has received the pre-feed command from the inspection server 31 (step 102 in FIG. 10) turns on the LED arrays 12A, 12B, and 14A, 14B (step 104). After that, the MCU outputs an operation start signal to the CPU of the image processing unit, drives the conveying motor FM via the actuator control unit, and causes the actuator control unit to output the number of conveying pulses also to the image processing unit (step 106). Thereby, the continuous business form F is conveyed at a constant speed in a direction of arrow A shown in FIG. 2, where the line scan cameras 11, 13 start image reading of the continuous business form F. The MCU refers to a signal from the sensor control unit to start monitoring of jam and so on of the continuous business form F.

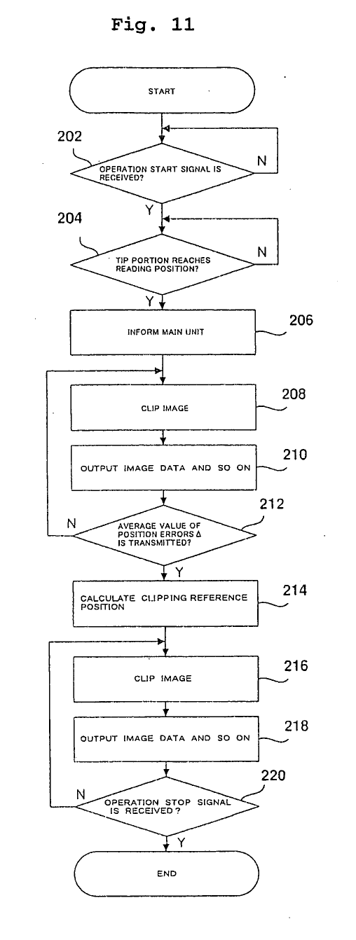

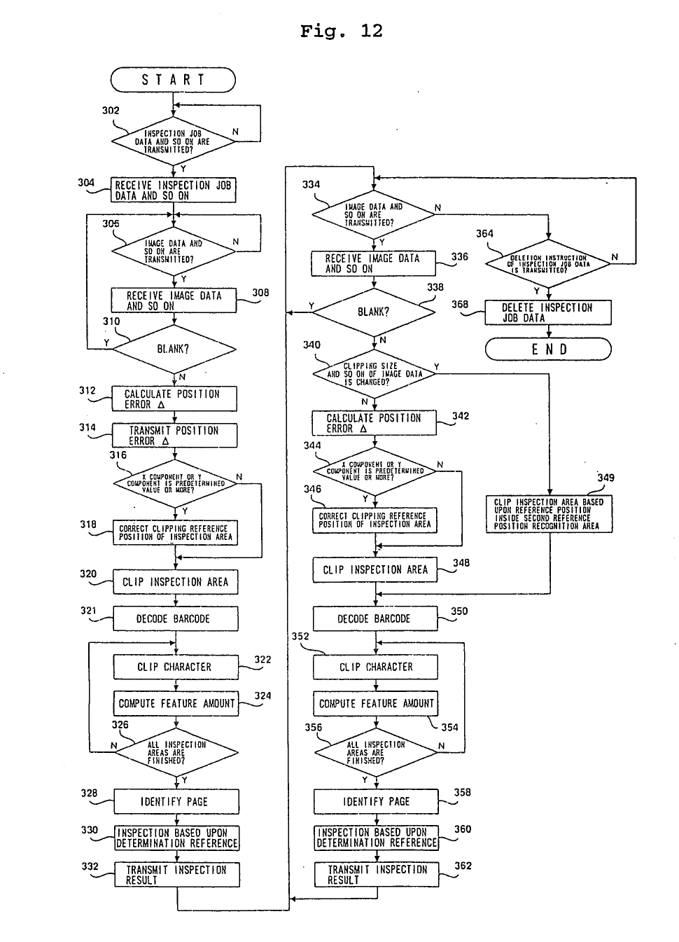

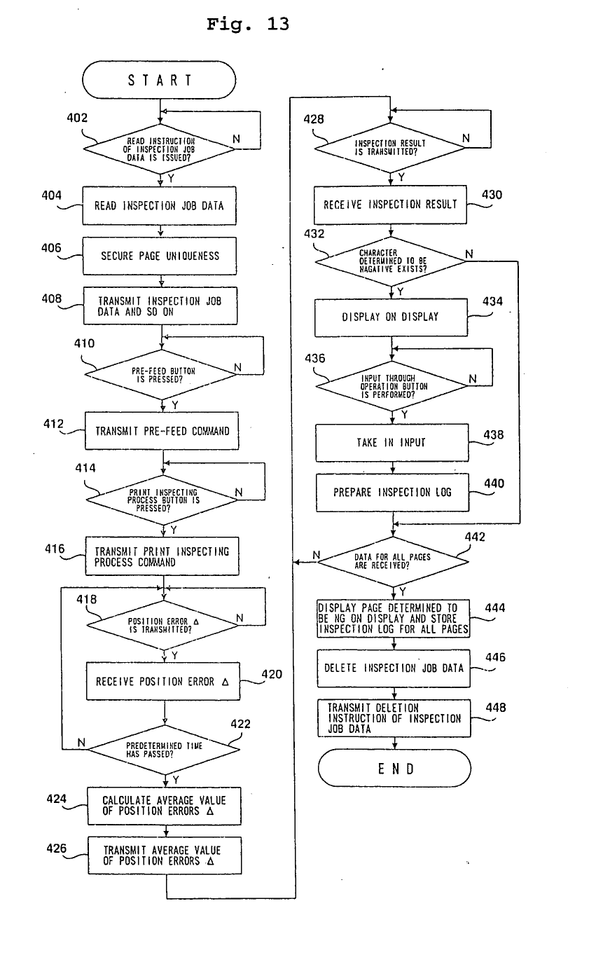

When (the CPU of) the image processing unit receives the operation start signal from the MCU of the main unit 10 (step 202 in FIG. 11), the image processing unit determines whether or not the tip portion of the continuous business form F is conveyed up to the reading position by monitoring the output from the surface line scan camera 11 (step 204) as same as in the case of the dictionary creation process. When the determination is affirmative, the image processing unit informs the MCU of the main unit 10 of the status (step 206). When the determination is negative, the image processing unit continues the determination whether or not the tip portion of the continuous business form F is conveyed up to the reading position (step 204).

When the MCU of the main unit 10 is informed from the image processing unit (step 108 in FIG. 10), the MCU stops the drive of the conveying motor FM after further driving the conveying motor FM for the predetermined number of pulses via the actuator control unit (step 110). The tip portion of the continuous business form F is thereby conveyed for a predetermined distance from the reading position of the surface line scan camera 11. The operator sets the tip portion of the continuous business form F to the folding apparatus 50 after the pre-feed convey of the continuous business form F is finished.

Subsequently, when the operator presses a predetermined button (a print inspection process button) among the operation buttons 31B (step 414 in FIG. 13), the inspection server 31 transmits a print inspection process command to the MCU of the main unit 10 (step 416).

When the MCU of the main unit 10 receives the print inspection process command from the inspection server 31 (step 112 in FIG. 10), the MCU drives the conveying motor FM again (step 114), and the print inspecting apparatus 1 starts the print inspection process. After that, the main unit 10 performs the print inspection process, but the MCU monitors if the remaining paper detecting sensor 22 detects an end of the continuous business form F or not. When the end of the continuous business form F is detected (step 116), the MCU outputs an operation stop signal to the CPU of the image processing unit, stops the reading by the line scan cameras 11, 13 (step 118), turns off the LED arrays 12A, 12B and 14A, 14B, and stops the drive of the conveying motor FM (step 120) to terminate the process.

The CPU of the image processing unit of the main unit 10 informs the MCU of the main unit 10 of the fact that the tip portion of the continuous business form F is conveyed up to the reading position, and thereafter, clips the image for one page at a rough position (refer to the image area IA in FIG. 6) according to the above-stated conveying amount management (step 208 in FIG. 11) as same as in the case of the dictionary creation process with reference to the data of the form (refer to FIG. 7) which is informed from the MCU of the main unit 10 in advance. The CPU of the image processing unit supplies the clipped image with a sequential image index, and outputs the clipped image data for one page and so on (the image data, the image index) to the control circuit 20 of the capture board 10B (step 210).

As described above, the control circuit 20 of the capture board 10B grasps the operation state of each inspection terminal 32 from the response and report transferred by the interface board 33 of the inspecting terminal, it determines a destination based upon the predetermined conditions, and it transmits the image data for one page and so on outputted from the image processing unit to the interface board of the determined inspecting terminal. The control circuit 34 of the interface board 33 of each inspection terminal 32 determines whether or not the designated unique number coincides with its own number. When the determination is affirmative, the control circuit 34 takes in the image data for one page and so on, but when the determination is negative, the control circuit 34 transfers the received image data for one page and so on to a downstream side inspecting terminal. Accordingly, the CPU of the image processing unit sequentially transmits the image data and so on to awaiting inspecting terminals 32 via the control circuit 20 of the capture board 10B.

Each inspection terminal 32 stores the inspection job data and the updated registration form information received from the inspection server 31 to the hard disk, and thereafter, waits until the image data and so on are transmitted from the control circuit 20 of the capture board 10B. When the image data and so on (the image data, the image index) are transmitted, each inspection terminal 32 receives them (steps 306, 308 in FIG. 12).

Next, each inspection terminal 32 performs the blank check determining whether the image of the received image data for one page is blank or a page where characters and so on are printed (step 310) as same as in the case of the dictionary creation process. Each inspection terminal 32 waits until the next image data and so on are transmitted because it is not necessary to perform the print inspection (returns to the step 306), when the page is determined to be blank.

On the other hand, when the page is determined to be the page where characters and so on are printed, each inspection terminal 32 calculates a position error Δ of the mark “ [symbol] ” inside the first reference position recognition area RPF1 (step 312). Namely, each inspection terminal 32 image-recognizes the mark “ [symbol] ” inside the first reference position recognition area RPF1 (further acquires pattern information by clipping the mark “ [symbol] ” if necessary, namely, when accuracy cannot be secured by the image recognition), and searches a coordinate matching with the pattern information of the mark “ [symbol] ” of the updated registration form information. Next, as shown in FIG. 8, a coordinate position (X′, Y′) of the mark “ [symbol] ” from the reference coordinate position R (0, 0) of the image area IA is acquired. The mark “ [symbol] ” is supposed to exist at a center position of the first reference position recognition area RPF1, namely at the position of the coordinate (X, Y) from the reference coordinate position R (0, 0) of the image area IA if a conveying error such as the loosening of the continuous business form F does not occur. As stated above, the position of the coordinate (X, Y) is defined when the continuous business form is manufactured, and it is included in the updated registration form information. Each inspection terminal 32 therefore calculates the position error Δ as (X-X′, Y-Y′). Subsequently, each inspection terminal 32 informs the inspection server 31 of the calculated position error Δ (step 314).

Next, each inspection terminal 32 determines whether or not an absolute value of an X component (X-X′), an absolute value of a Y component (Y-Y′) of the position error Δ are each equal to or more than predetermined values defined in advance (step 316). Namely, when either of the absolute value of the X component or Y component of the position error Δ is equal to or larger than the predetermined value, an error may occur in the position of the mark “ [symbol] ” a being a reference to clip each inspection area EF (hereinafter, called as a clipping reference position). A correction of the clipping reference position is therefore required, at the same time, a process time becomes long when the correction of the clipping reference position is performed even when the position error Δ is minute. Accordingly, each inspection terminal 32 determines whether or not the correction of the clipping reference position of the inspection area EF and the barcode area BC is necessary even though the process time is sacrificed, in step 316. When the determination is affirmative, the clipping reference position is corrected in both X direction and Y direction to clip each inspection area EF and the barcode area BC while using the corrected clipping reference position as the reference (steps 318, 320). When the determination is negative, each inspection area EF and the barcode area BC are clipped without correcting the clipping reference position (step 320). Incidentally, each inspection terminal 32 clips the images of the inspection area EF and the barcode area BC by recognizing the registration form name from the inspection job data, and acquiring the positional information of the inspection area EF from the registration form name.

Next, each inspection terminal 32 image-recognizes and decodes the barcode inside the barcode area BC with reference to the inspection job data in step 321, determines whether or not decoded barcode information matches with the data of the barcode in the inspection job data. When the determination is affirmative, the process goes to step 322, and when determination is negative, each inspection terminal 32 informs the inspecting server of the fact (not shown). Incidentally, a technology to image-recognize and decode the barcode is publicly known, and such publicly known technology is used to decode the barcode in the embodiment. Subsequently, each inspection terminal 32 clips the character image one character by one character from the image inside the inspection area EF (step 322), divides into the above-stated predetermined small areas, computes the feature vectors about slopes of respective small areas in an image forming direction, and computes the feature amounts by multiplying the weight coefficients by the respective feature vectors (step 324). Next, each inspection terminal 32 determines whether or not the feature amounts are computed as for the characters of all of the inspection areas EF (step 326). When the determination is negative, the process returns to the step 322 to continue the character clipping as for the next inspection area EF. When the determination is affirmative, each inspection terminal 32 searches the character string in the field number corresponding to the uniqueness specific area of the inspection job data having the feature amount matching with the feature amount of each character in the uniqueness specific area (the same character string), and specifies a page to which the received image data for one page corresponds (step 328). Next, each inspection terminal 32 extracts a collation job data of the character in the corresponding page from the inspection job data, and specifies the inspection job data (correct solution information) of the inspection area EF to determine whether or not the computed feature amount is equal to or more than a determination reference value relative to the feature amount corresponding to the clipped character in the dictionary (step 330). When the determination is affirmative, it is determined that the character clipped from the image inside the inspection area EF (the character to be inspected) is correctly printed on the continuous business form F by the system printer 70.

Each inspection terminal 32 collects determination results in a page unit to transmit them to the inspection server 31 as an inspection result (step 332). At this time, regarding a character which has been subjected to negative determination (determined that the character has not been printed properly), each inspection terminal 32 transmits attribute information regarding the character (page, inspection area, information about what number of character and character information) and image data of the image clipped from the inspection area EF about the character to the inspection server 31. The process for the first page on which the characters and so on are printed is thereby finished.

On the other hand, the inspection server 31 transmits the print inspection process command to the MCU of the main unit 10, and thereafter, waits until the position error Δ is transmitted from either of the inspecting terminals (step 418 in FIG. 13). The inspection server 31 receives the position error Δ when it is transmitted (step 420), and thereafter, receives the position error Δ if the position error Δ is transmitted from the other inspecting terminals within a predetermined time (steps 418 to 422). Next, an average value of the received position errors Δ is calculated (step 424). Incidentally, the position error Δ is resulting from the loosening and so on of the continuous business form F at the main unit 10 side, and therefore, it is not necessarily required to receive the position errors Δ from all of the inspecting terminals 32 when the average value of the position errors α is calculated. For example, the position error Δ received by either one of the inspecting terminals may be used (the step 422 is not necessarily required). Next, the inspection server 31 transmits the calculated average value of the position errors Δ to the CPU of the image processing unit (step 426).

The CPU of the image processing unit receiving the average value of the position errors Δ from the inspection server 31 (step 212 in FIG. 11) calculates the clipping reference position so as to offset (remove) the position error of position error Δ for the extent of the average value (step 214), and clips the image including the inspectable area RF while using the calculated clipping reference position as the reference (for example, an image larger than the inspectable area RF for 3 mm each in both X and Y directions, total of 6 mm larger, so as to prevent a partial lack of the mark “ [symbol] ”) (step 216). After that, the CPU of the image processing unit outputs the clipped image data and the image index to the control circuit 20 of the capture board 10B (step 218). Accordingly, the area of the image for one page to be clipped is changed from the image area IA to the image slightly larger than the inspectable area RF of which reference is the clipping reference position (the image of which area is smaller than the image area IA), and each inspection terminal 32 acquires the image including the inspectable area RF as the image data for one page. Incidentally, a specific character is added to the image index so as to inform each inspection terminal 32 of the changes in the reference position of the clipping and the image size. Hereinafter, the CPU of the image processing unit continues the clipping of the image including the inspectable area RF of which reference is the clipping reference position in which the position error is offset, until the operation stop signal is received from the MCU of the main unit 10, and terminates the process when the operation stop signal is received from the MCU of the main unit 10 (step 220).

Each inspection terminal 32 determines whether or not the next image data and so on are transmitted (step 334 in FIG. 12) after the process of the first page on which the characters and so on are printed is finished. When the determination in the step 334 is negative, each inspection terminal 32 determines whether or not a deletion instruction of the inspection job data is transmitted from the inspection server 31 (also refer to step 364, step 448 in FIG. 13). When the determination is negative, the process returns to the step 334, and when the determination is affirmative, each inspection terminal 32 deletes the inspection job data (step 368) to terminate the process. On the other hand, when the determination in the step 334 is affirmative, each inspection terminal 32 receives the image data and so on as same as in the case of the steps 308, 310 (step 336), to perform the blank check (step 338).

When the page is determined to be blank as the result of the blank check, each inspection terminal 32 waits until the next image data and so on are transmitted because the print inspection is not necessary (the process returns to the step 334). On the other hand, when the page is determined to be the page on which characters and soon are printed, each inspection terminal 32 determines whether or not the clipping reference position and the image size are changed as for the image data by determining whether or not the specific character is added to the image index (step 340). When the determination in the step 340 is negative, each inspection terminal 32 calculates the position error Δ of the position of the mark “ [symbol] ” inside the first reference position recognition area RPF1 as same as in the steps 312, 316 to 321 (step 342). Each inspection terminal 32 then determines whether or not the absolute value of the X component (X-X′) and the absolute value of the Y component (Y-Y′) of the position error Δ are each equal to or more than the predetermined values defined in advance (step 344). When the determination is affirmative, each inspection terminal 32 clips each inspection area EF and the barcode area BC while correcting the clipping reference position in both X direction and Y direction (steps 346, 348). When the determination is negative, each inspection terminal 32 clips each inspection area EF and the barcode area BC without correcting the clipping reference position (step 348), and decodes the barcode of the barcode area BC (step 350).

On the other hand, when the determination in the step 340 is affirmative, each inspection terminal 32 image-recognizes the mark “ [symbol] ” inside the second reference position recognition area RPF2 of which area is smaller than the first reference position recognition area RPF1 (further acquires the pattern information by clipping the mark “ [symbol] ” if necessary), searches the coordinate matching with the pattern information of the mark “ [symbol] ” of the updated registration form information, clips the inspection area EF and the barcode area BC by using the position of the mark “ [symbol] ”, namely, the clipping reference position as the reference (step 349), and the process goes to step 350. In succeeding steps 352 to 362, each inspection terminal 32 performs the inspection by clipping the characters of each inspection area EF as same as in the steps 322 to 332, transmits the inspection result for one page to the inspection server 31, and the process returns to the step 334.

Here, when the process contents (steps 342 to 348) when the determination in the step 340 is negative and the process contents (step 349) when the determination is affirmative are compared, they are different in the following points: (1) the point in which the former aims at the mark “ [symbol] ” inside the first reference position recognition area RPF1, but the latter aims at the mark “ [symbol] ” inside the second reference position recognition area RPF2; and (2) the point in which the former determines the necessity of the correction by the position error Δ and clips each inspection area EF while performing the correction by the position error Δ (performing the correction of the clipping reference position) as necessary, but the latter clips each inspection area EF without performing the correction by position error Δ. This is because the accuracy of the clipping position is enhanced because the inspection terminal 32 transmits the position error Δ to the inspection server 31 (step 314), the inspection server 31 calculates the average value of the position errors Δ and transmits to the CPU of the image processing unit (steps 424, 426 in FIG. 13), and thereby, the CPU of the image processing unit clips the image while correcting the clipping reference position so as to offset (set-off) the position error for the extent of the average value of the position error Δ.

The inspection server 31 receiving the inspection result (steps 428, 430 in FIG. 13) determines whether or not the character determined to be negative exists (step 432). When the determination is affirmative, the inspection server 31 simultaneously displays both the image of the character extracted by sequentially referring to the dictionary using the character information included in the attribute information as an index and the image of the character clipped from the inspection area EF and transmitted from the inspection terminal 32 on the display 31A (step 434) as for the character which is determined to be not printed properly, and waits until a predetermined button among the operation buttons 31B is pressed such that an operator can make determination about OK or NG visually (step 436). When the operation button is pressed, the inspection server 31 takes in the inputted information. When the information indicates OK, the inspection server 31 additionally registers the feature amount of the clipped character (the character determined to be OK by the visual inspection of the operator) to the dictionary as an additional feature amount while using the character information as the index, adds information defining a correspondence with the image data to the dictionary, and prepares the determination result (OK) based upon the inspection result and the visual inspection of the operator as an inspection log of the page. When the information indicates NG, the inspection server 31 prepares the determination result (NG) based upon the inspection result and the visual inspection by the operator as the inspection log of the page (steps 438, 440). Incidentally, when the inspection server 31 is informed of a state indicating that the decoded barcode information does not match with the data of the barcode in the inspection job data from each inspection terminal 32 in the steps 321, 348 in FIG. 12, the inspection server 31 prepares the inspection log of the page indicating the inconsistency as same as the processes in the steps 438, 440.

On the other hand, when the inspection server 31 determines that no character determined to be negative exists in the inspection result received from the inspection terminal 32, it refers to the page data among the inspection job data to wait until it receives the inspection results as for all pages, and performs similar processes as the above (step 442) to store the inspection log of all pages (step 444). The inspection server 31 transmits the character information and the additional feature amount of the character whose additional feature amount has been registered to each inspection terminal 32 to update the information in the dictionary, deletes the inspection job data (step 446), and transmits a deletion instruction of the inspection job data and so on to each inspection terminal 32 (step 448) to thereby terminate the print inspection. When each inspection terminal 32 receives the instruction (step 364 in FIG. 12), it deletes the inspection job data (step 368) to terminate the process. Thereby, when the processing unit 30 next inspects characters printed on the continuous business form F by the system printer 70, it determines whether or not the feature amounts corresponded to the dictionary are in plural. When there are plural feature amounts, the processing unit 30 determines whether or not the feature amount of the clipped character is equal to or more than the determination reference value relative to either of the feature amounts corresponded to the dictionary. When the determination is negative, the processing unit 30 determines whether or not the feature amount of the clipped character is equal to or more than the determination reference value relative to any of the other feature amounts. Incidentally, the page determined to be NG can be printed again by the system printer 70 through reference to the inspection log, or it may be corrected by handwriting or the like.

(Operation and the Like)

Next, an operation and effect of the print inspecting apparatus 1 according to the embodiment will be explained.

In the print inspecting apparatus 1 according to the embodiment, the CPU of the image processing unit of the main unit 10 clips the image area IA which is larger than the inspectable area RF according to the number of conveying pulses (the conveying amount management) outputted to the conveying motor FM (step 208) before the position error Δ of the clipping reference position is grasped. Each inspection terminal 32 calculates the position error Δ from the image of the clipped image area IA (step 312), corrects the clipping reference position when the X component or the Y component of the position error Δ is equal to or more than the predetermined value, and clips the inspection area EF by using the clipping reference position as the reference without performing the correction of the clipping reference position when the X component and the Y component of the position error Δ are less than the predetermined value (steps 316 to 320). As stated above, the loosening is easy to occur at the tip portion of the continuous business form F, and this loosening causes the inconsistency with the conveying amount of the conveying motor FM in each page. Accordingly, the CPU of the image processing unit clips the image area IA larger than the inspectable area RF, each inspection terminal 32 clips a plurality of inspection areas EF while correcting the position error Δ of the clipping reference position according to needs. As a result, a necessity of the correction process is reduced to shorten the process time in each inspection terminal 32, and the image can be clipped without generating any lacking in the clipped image.

On the other hand, when the above-stated process is performed continuously (the image processing unit clips the image area IA larger than the inspectable area RF necessary for the inspection by the inspection terminal 32), the clipped area becomes large, and the transmission time of the image data from the image processing unit to each inspection terminal 32 also becomes long. Accordingly, the CPU of the image processing unit corrects the clipping reference position so as to offset (set-off) the average value of the position error Δ of the clipping reference position after the position error Δ of the clipping reference position is grasped (step 214) to clip the image of the inspectable area RF by using the corrected clipping reference position as the reference (step 216). Each inspection terminal 32 clips a plurality of areas from the image of the inspectable area RF by using the clipping reference position as the reference (step 349) without correcting the position error Δ of the clipping reference position. Owing to the process as stated above, it is possible to shorten the transmission time of the image data from the image processing unit to each inspection terminal 32, and to realize the shortening of the process time for the extent of the time necessary for the correction process because each inspection terminal 32 clips the plurality of areas from the image of the inspectable area RF by using the clipping reference position as the reference without correcting the position error Δ of the clipping reference position.

In the print inspecting apparatus 1 according to the embodiment, the mark “ [symbol] ” forming the corner of the inspectable area RF of the continuous business form F and the position thereof (the clipping reference position) are set in advance in the form registration process. The CPU of the image processing unit clips the image for approximately one page according to the “data of the form” of the inspection job data before the position error Δ of the clipping reference position is grasped, and clips the image slightly larger than the inspectable area RF by using the clipping reference position as the reference after the position error Δ of the clipping reference position is grasped in the print inspection process. There is no mark for a page image clipping in the continuous business form F as a business form used in the Patent Document 1. According to the print inspecting apparatus 1 of the embodiment, it is possible to clip the image properly by using the conventionally used form without adding the mark for the page image clipping (a start mark or an end mark) to the continuous business form F (without changing a version of the continuous business form F).

In the print inspecting apparatus 1 according to the embodiment, the first reference position recognition area RPF1 and the second reference position recognition area RPF2 smaller than the first reference position recognition area RPF1 and of which center positions are the same are set in advance in the form registration process. Each inspection terminal 32 clips the inspection area EF and the barcode area BC by recognizing the mark “ [symbol] ” inside the first reference position recognition area RPF1 because the conveying error is large before the position error Δ of the clipping reference position is corrected (steps 312 to 320, steps 342 to 348), and clips the inspection area EF and the barcode area BC by recognizing the mark “ [symbol] ” inside the second reference position recognition area RPF2 because a large and fixed error resulting from the conveying error does not exist after the position error Δ of the clipping reference position is corrected (step 349). Accordingly, the search time of the clipping reference position by each inspection terminal 32 can be shortened.

In the print inspecting apparatus 1 of the embodiment, the CPU of the image processing unit corrects (calculates) the clipping reference position only for once so as to eliminate the position error Δ of the clipping reference position (step 212), and thereafter, the image of the inspectable area RF is clipped based on the calculated clipping reference position. Accordingly, it is possible to shorten the process time required for the clipping of the image because the large and fixed error resulting from the conveying error does not exist and there is no need to perform the correction every time when the inspectable area RF in each page of the continuous business form F is clipped.

In the print inspecting apparatus 1 of the embodiment, the inspection server 31 specifies the corresponding field number in the inspection job data stored in the hard disk based on the positional information of the uniqueness specific area among the registration form information stored in the hard disk, and determines whether or not there is the data matching (same) with the data in the field number in a page unit before the print inspection process is performed. According to the print inspecting apparatus 1 of the embodiment, the page of the image data and the page (physical page) of the actual continuous business form do not correspond, and it is prevented that the correct solution information is extracted by mistake.

In the print inspecting apparatus 1 of the embodiment, the inspection server 31 autonomously increases/decreases the number of the uniqueness specific areas (field number) based on the uniqueness specific areas set in the form registration process as stated above (step 406). According to the print inspecting apparatus 1 of the embodiment, it is possible to realize the securing of the uniqueness in a page unit and the shortening of the process time.

In the print inspecting apparatus 1 of the embodiment, the main unit 10 reads the characters printed on the continuous form for dictionary preparation by the system printer 70 in the predetermined format with correspond to the character information, the processing unit 30 computes the feature amounts of all characters, and the dictionary in which the correspondence between the computed feature amounts of all characters and the character information of all characters inputted in advance and capable of being printed on the continuous business form F by the system printer 70 is defined is prepared. Accordingly, it is possible for the processing unit 30 to determine whether or not the character is correctly printed on the continuous business form F by the system printer 70 even if the character to be inspected is an external character.

In the print inspecting apparatus 1 of the embodiment, the dictionary defining the correspondence between all characters which can be printed on the continuous business form F by the system printer 70 and the feature amounts thereof is prepared in advance in the dictionary creation process, the image of the character printed on the continuous business form F is clipped, the feature amount thereof is computed, and the feature amounts are collated with each other while using the collation job data (correct solution information) as the index in the print inspection process. Since the processing unit 30 (inspection terminal 32) collates the feature amounts with each other, a complicated character recognizing process using a recognition function or the like is not required. Therefore, any complicated process for character recognition is not required, so that error occurrence in character recognition can be prevented. Since the feature amounts are collated with each other, it is unnecessary to prepare logic at the collation time by each character information.

In the print inspecting apparatus 1 of the embodiment, since the feature amounts of the characters printed by the same printer are collated with each other, influence due to individual differences of printers can be excluded without being affected by fine difference in shape of font between printers. In the print inspecting apparatus 1 of the embodiment, since determination is made by the processing unit 30 whether the feature amounts are equal to or more than the determination reference value, the print inspection can be performed flexibly at high precision by setting the determination reference value properly.

In the print inspecting apparatus 1 of the embodiment, even if it is once determined by the processing unit 30 that the feature amount is less than the determination reference value, the determination result of the operator can be inputted via the display 31A and the operation button 31B, and therefore, it is possible to correspond to an aging degradation of the system printer 70. Further, since the feature amount of the character whose feature amount has been once determined to be less than the determination reference value can be registered to the dictionary as the additional feature amount according to the determination result of the operator and the dictionary has a data structure capable of having plural additional feature amounts, the print inspection can be sequentially performed for the plural feature amounts, so that a learning function can be provided at the print inspecting apparatus 1. In this case, if a determination is first made for the feature amount of the character to be inspected whether it is equal to or more than the determination reference value relative to the additional feature amount which is added to the dictionary at the latest, correspondence to the aging degradation of the system printer 70 can be improved.

In the print inspecting apparatus 1 of the embodiment, since a plurality of computers constitute the inspecting terminals 32, the inspection server 31 transmits the image read by each page to the awaiting inspection terminal 32 to perform processes such as the feature amount computation in parallel, and the inspection terminal 32 only determines whether or not the characters in the inspection area EF set in the form registration process has been printed on the continuous business form F correctly, the print inspection can be performed rapidly.

In the print inspecting apparatus 1 of the embodiment, since the print inspection is performed in off-line manner, and the dictionary creation process, the form registration process, and the print inspection process can be performed by each of the plural printers (since these processes are not restricted to a specific printer), high versatility can be secured.

In the print inspecting apparatus 1 of the embodiment, the control circuit 20 of the capture board 10B grasps the operation state of each inspection terminal 32 based on the response and report transferred by the interface board 33 of the inspecting terminal to determine the inspection terminal 32 to be a destination of the image data and the like, and transmits image data for one page to the interface board of the determined inspection terminal 32. The control circuit 34 of the interface board 33 in each inspection terminal 32 determines whether or not the designated unique number coincides with its own number. When the determination is affirmative, the control circuit 34 takes in the image data for one page and the like, but when the determination is negative, the control circuit 34 transfers the received image data for one page and the like to an interface board of a downstream side inspecting terminal. Accordingly, when the print inspection process is performed in a daisy-chain configuration, the image data for one page can be sequentially transmitted to the awaiting inspecting terminals 32, thereby raising an operating rate of the inspecting terminals 32.

In the embodiment, the example is shown in which the inspectable area RF is clipped by using the mark “ [symbol] ” forming the corner of the inspectional area RF as the reference for simplification in explanation. However, the present invention is not limited to the example. For example, the clipping reference position of the inspectable area RF may be set by using a first character “G” of “Glory Card Utilization Charge Bill” printed inside the inspectable area RF of the continuous business form F in advance as a reference. The clipping reference position of the inspectable area RF may be set by using a barcode printed in the barcode area BC as a reference. In the embodiment, the example is shown in which the inspectable area RF is clipped by using one mark “ [symbol] ” forming the corner of the inspectable area RF as the reference, but a plurality of characters, marks, or barcodes to be the reference may be provided. Namely, for example, the inspectable area RF may be clipped by using two marks of the mark “ [symbol] ” forming the corner of the inspectable area RF and a mark “ [symbol] ” forming the corner of the inspectable area RF and facing the mark “ [symbol] ” as the reference.

In the embodiment, the example is shown in which the CPU of the image processing unit clips the image of the inspectable area RF by correcting the clipping reference position after the position error Δ of the clipping reference position is grasped (step 214), and each inspection terminal 32 clips the plural areas from the image of the inspectable area RF by using the clipping reference position as the reference without correcting the position error Δ of the clipping reference position (step 349). However, the present invention is not limited to the example, and each inspection terminal 32 may correct the position error Δ of the clipping reference position to clip the inspection area EF. Accordingly, it is possible to correct the position error Δ with higher precision, and therefore, for example, inspection quality in the print inspection of a character in a small point can be improved. In the embodiment, the example is shown in which the position error Δ is simply set as (X-X′, Y-Y′), but the present invention is not limited to the example. For example, it is possible to perform a skew correction as disclosed in the Patent Document 1, when the characters, marks or barcodes to be the reference are provided in plural as stated above.

In the embodiment, the example is shown in which two reference position recognition areas are set in the form registration process, but three or more reference position recognition areas may be set and the position errors Δ are grasped for plural times in the print inspection process to determine whether or not the character and soon to be the reference is fallen inside a smaller reference position recognition area. When the determination is affirmative, the character and so on to be the reference may be searched inside the smaller reference position recognition area.

In the embodiment, the example is shown in which the position error Δ of the clipping reference position is corrected by software so as to eliminate the position error Δ, but the present invention is not limited to the example. For example, the number of conveying pulses outputted to the conveying motor FM may be changed so as to eliminate the position error Δ to perform the correction.

In the embodiment, the example is shown in which the received image is specified to which page it corresponds to, while assuming that each character inside each inspection area EF satisfies the inspection based on the determination reference (step 328) for simplification in explanation. However, for example, the data processed up to that time is stored in the hard disk when one or more characters do not satisfy the determination reference among the characters inside each inspection area. At the time when it turns out that the image corresponds to which page in a process of the image of the other page, the data stored in the hard disk is read to continue the suspended process. Then the image index of the image of which corresponding page is turned out and the image index of the image of the data stored in the hard disk are compared making use of the fact that the image index is sequential, to thereby determine the page to which the image of the data stored in the hard disk corresponds. Otherwise, the page to which the image corresponds may be informed by the inspection server 31 as same as the case in the dictionary creation process.

In the embodiment, the example is explained in which the character on the continuous business form F printed by the system printer 70 offline is inspected. As explained in the Explanation of Related Art, however, when a series of processes from printing on the continuous business form F to sealing of an envelope are continuously performed and so on, an on-line configuration can be taken. In this case, the continuous business form F discharged from the system printer 70 may be set at the main unit 10 by using a loop stand with some buffer, and the print server 60 and the processing unit 30 may be connected through a communication line.

In the embodiment, the example is shown in which the images on the continuous business form are read by using the high-speed line sensor, but an area sensor may be used in order to elevate a reading speed. In the embodiment, the example is shown in which both faces of the continuous business form F are read, but it goes without saying that a constitution where only one face of the continuous business form F is read may be taken.

In the embodiment, as shown in FIG. 7, the example is shown in which the code for identifying the printer or the code for identifying the form may be provided to the inspection job data, but such a constitution can be taken that the operator inputs these information from the operation buttons 31B while excluding these information from the inspection job data.

In the embodiment, the example is shown in which the character printed on the continuous form for dictionary preparation is specified based on the character information in the predetermined format in the dictionary creation process, but the correct solution information may be used as same as in the print inspection process. In the embodiment, the example is shown in which the character printed on the continuous business form is inspected, but the present invention is not limited to the example. For example, it goes without saying that the present invention can be applied to a print inspecting apparatus which continuously or intermittently inspects characters printed on a single form.

In the embodiment, the example is shown in which the dictionary defining the correspondence between all characters which can be printed on the continuous business form F by the system printer 70 and the feature amounts thereof is preliminarily prepared, the images of the characters printed on the continuous business form F are clipped, the feature amounts of the characters are computed, and the feature amounts are collated with each other by using the collation job data as the index. However, the present invention can be applied to an image collation technique where image data used in printing and image data read from a printed matter are collated with each other, and a character collation technique where printed character is read and is applied with OCR process, character recognition is performed, and a result obtained by converting into character data is collated.

In the embodiment, the example is shown in which the interface board 33 has a page memory for two pages, but the present invention is not limited to the example. The interface board 33 may be constituted to have a page memory for one page or a page memory for three or more pages. For example, when the interface board 33 has the page memory for one page, it is necessary to satisfy the above-described condition (1) as the above-described predetermined conditions. In the embodiment, the example is shown in which the awaiting interface board is determined from the upstream side, but the present invention is not limited to this embodiment. Such a constitution may be taken that image data or the like is transmitted to any awaiting interface board.

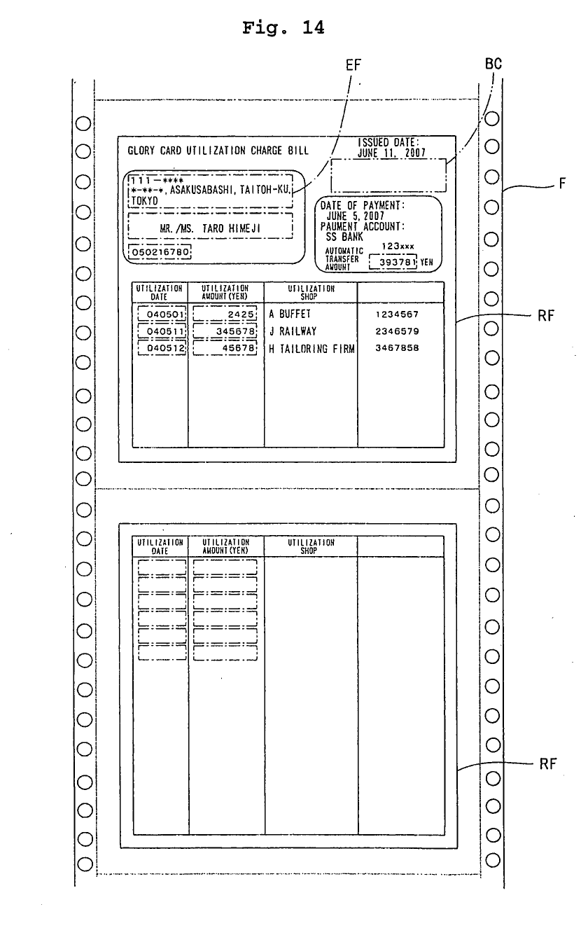

The present invention is also applicable for a case when the continuous business form F is a multi-form business form and a case when the barcode area BC is disposed inside the inspectable area RF. Here, the “multi-form” means a form forming one unit by plural forms, and for example, a form can be cited as the “multi-form” in which a form forming a second page of the multi-form (the form at the lower side in FIG. 14) is different from a form forming a first page of the multi-form (the form at the upper side in FIG. 14) in a point having no inspection area specifying a customer (address, name, customer code), barcode area, inspection area for automatic transfer amount. Hereinafter, the different points and processes from the above-stated embodiment regarding the multi-form business form (continuous business form F) are described.

[Setting of Reference Position Recognition Area]

As stated above, the relationship between the reference coordinate position R (0, 0) and the coordinate position (X, Y) of the mark “ [symbol] ” forming the corner of the inspectable area RF is already known when the continuous business form F is manufactured (in this example, the position of the reference coordinate position R is set to be the position at 3 mm from the perforation forming the boundary of one page of the continuous business form in both X direction and Y direction in consideration of a conveying amount error). The size of the first reference position recognition area RPF1 is set in advance so that the inconsistency caused by the loosening can be absorbed (displayed on the display 31), and the operator sets the first reference position recognition area RPF1 to be the size larger than the displayed size. In the multi-form business form, the position of the mark “ [symbol] ” forming the corner of the inspectable area RF and the position of the inspectable area RF of the form forming the second page of the multi-form are printed at the same position with the position of the mark “ [symbol] ” forming the corner of the inspectable area RF and the position of the inspectable area RF of the form forming the first page of the multi-form. However, when the both are different, the relationship among the reference coordinate position R (0, 0) of the image area IA, the coordinate position (X, Y) of the mark “ [symbol] ” forming the corner of the inspectable area RF and the coordinate position of the inspectable area RF may be set separately.

[Setting of Inspection Area]

The inspection server 31 acquires information to distinguish between the first page and the second page in addition to the information of the coordinate positions of the inspection areas EF because the coordinate positions of the inspection areas EF of the first page and the second page of the multi-form are different, in the multi-form business form, in addition to acquire the positional information of the inspectable area RF and the inspection area EF as the coordinate position (X, Y) of the mark “ [symbol] ”

[Setting of Uniqueness Specific Area]

In the multi-form business form, for example, an area of a customer code in the first page of the multi-form (“(050216780” in FIG. 14) in which the uniqueness is easy to secure can be selected as the uniqueness specific area.

[Setting of Barcode Area]

The inspection server 31 acquires the positional information of the barcode area BC as the coordinate position (X, Y) of the mark “ [symbol] ” as same as in the above-stated embodiment, but the barcode area BC is designated only at the first page of the multi-form, and the barcode area BC is not designated at the second page in case of the multi-form business form.

[Registration Form Information]

FIG. 14 shows an example where 10 inspection areas EF and one barcode area BC have been designated at the first page of the multi-form, and 12 inspection areas EF have been designated at the second page of the multi-form.

[Securing of Page Uniqueness according to Uniqueness Specific Area]

The inspection server 31 at first refers to the inspection job data, determines whether or not it is a page on which a barcode is printed (the first page of the multi-form) in step 406 in FIG. 13 (also refer to FIG. 14). It is determined whether or not there is uniqueness in a page unit in a combination of the character strings (data) at a plurality of field numbers corresponding to the uniqueness specific area, as for the page determined to be affirmative. The following process is the same as the process in the above-stated embodiment.

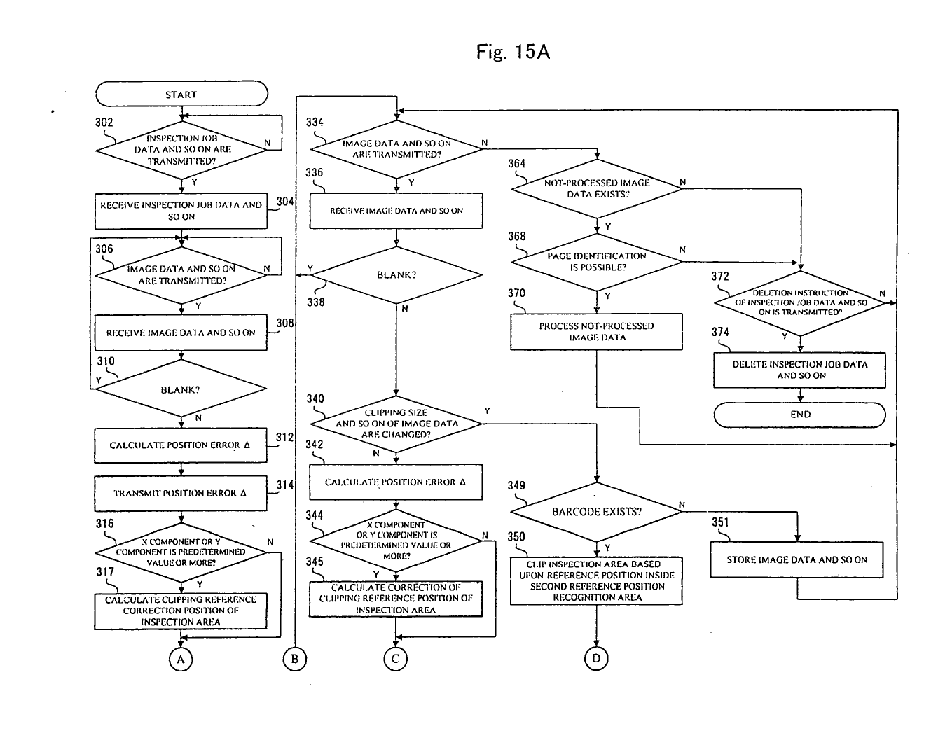

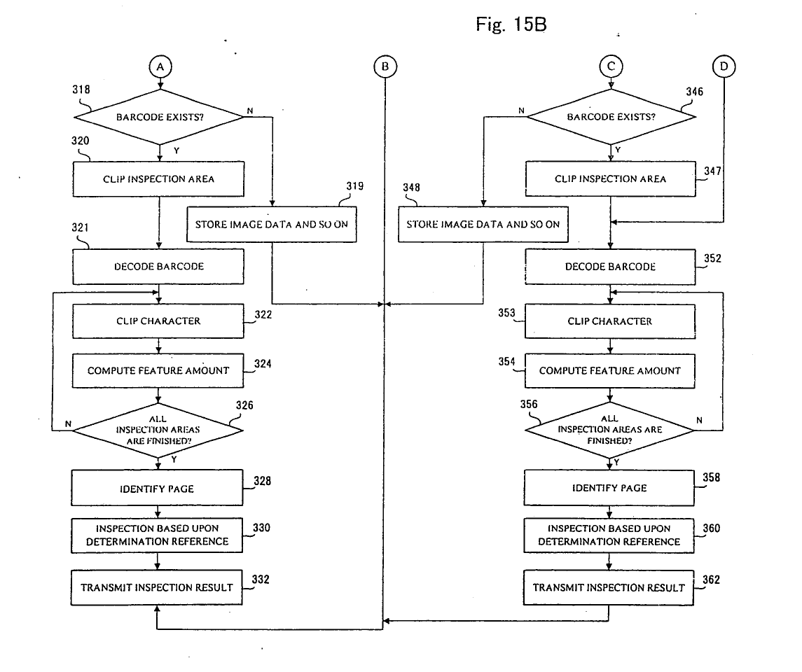

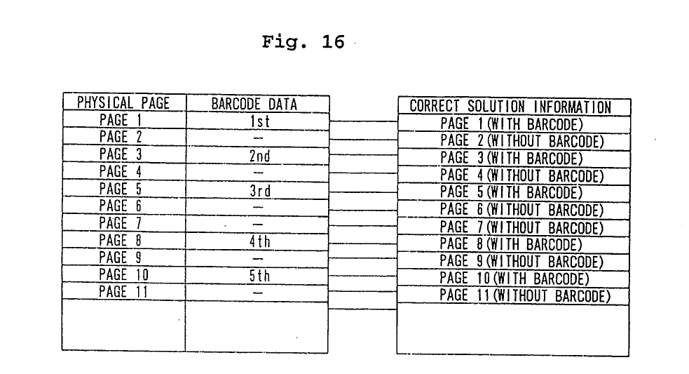

In case of the multi-form business form, each inspection terminal executes a process routine of a flowchart shown in FIGS. 15A and 15B instead of the flowchart shown in FIG. 12, in the print inspection process. Incidentally, in FIGS. 15A and 15B, a process in step 317 corresponds to the process in the step 318 in FIG. 12, a process in step 345 corresponds to the process in the step 346 in FIG. 12, a process in step 347 corresponds to the process in the step 348 in FIG. 12, a process in step 350 corresponds to the process in the step 349 in FIG. 12, processes in steps 352, 353 correspond to the processes in the steps 350, 352 in FIG. 12, and processes in steps 372, 374 correspond to the processes in the steps 364, 368 in FIG. 12, respectively. Further, steps 318, 319, 346, 348, 349, 351, 364, 368, and 370 in FIGS. 15A, 15B are added to FIG. 12. Hereinafter, the print inspection process performed by each inspecting terminal is described with reference to FIGS. 15A, 15B, where the descriptions as for the same steps as FIG. 12 are not given, and different process routines are described.

In the step 316, it is determines whether or not a correction of the clipping reference positions of the inspection area EF and the barcode area BC is necessary even though the process time is sacrificed, as stated above. When the determination is affirmative, a clipping reference correction position to correct the clipping reference position in both X direction and Y direction is calculated (step 317), and the process goes to step 318. When the determination is negative, the process goes to the step 318 because the correction is not necessary. Next, each inspecting terminal image-recognizes whether or not a barcode exists in a predetermined area (barcode area BC) of an image data received in the step 308 (step 318). When the determination is negative, the image data and so on received in the step 308 is once stored in the hard disk (step 319), and waits until the next image data and so on are transmitted. When the determination is affirmative, each inspecting terminal recognizes a registration form name from the inspection job data, acquires positional information of the inspection area EF from the registration form name, and clips each inspection area EF and the barcode area BC by using the clipping reference position (when it is determined to be negative in the step 316) or the clipping reference correction position (when it is determined to be affirmative in the step 316) as a reference (step 320).

The inspection terminal 32 is able to grasp a relationship between the image index and the physical page of the continuous business form F as for the image on the first page of the multi-form where the barcode is included by the process in the step 328.

Each inspection terminal 32 finishes the process of the first page where the characters and so on are printed, and thereafter, determines whether or not the next image data and soon are transmitted (step 334 in FIG. 12). When the determination in the step 334 is affirmative, each inspection terminal 32 receives the image data and so on (step 336) and performs the blank check (step 338) as same as in the case of the steps 308, 310. When the page is determined to be blank as a result of the blank check, each inspecting terminal waits until the next image data and so on are transmitted because there is no need for the print inspection (the process returns to the step 334). On the other hand, when the page is determined to be the page where the characters and so on are printed, each inspection terminal 32 determines whether or not a specific character is added to the image index, to thereby determine whether the clipping reference position and the image size are changed as for the image data (step 340). When the determination in the step 340 is negative, the position error Δ of the position of the mark “ [symbol] ” inside the first reference position recognition area RPF1 is calculated (step 342) as same as in the cases of the steps 312, 316 to 321. Each inspection terminal 32 determines whether or not each of the absolute value of the X component (X-X′) and the absolute value of the Y component (Y-Y′) of the position error Δ are equal to or more than the predetermined values which are defined in advance (step 344). When the determination is affirmative, the clipping reference correction position to correct the clipping reference position in both X direction and Y direction is calculated (step 345) as same as the step 317, and the process goes to the step 346. When the determination is negative, the process goes to the step 346. Next, each inspection terminal 32 image-recognizes whether or not the barcode exists in the barcode area BC of the image data received in the step 336 (step 346). When the determination is negative, each inspection terminal 32 once stores the image data and so on received in the step 336 to the hard disk (step 348), and waits until the next image data and so on are transmitted. When the determination is affirmative, each inspection terminal 32 recognizes the registration form name from the inspection job data, acquires the positional information of the inspection area EF from the registration form name, clips each inspection area EF and the barcode area BC by using the clipping reference position (when it is determined to be negative in the step 344) or the clipping reference correction position (when it is determined to be affirmative in the step 344) as the reference (step 347), and decodes the barcode of the barcode area BC (step 352).

On the other hand, when the determination in the step 340 is affirmative, each inspecting terminal image-recognizes whether or not the barcode exists in the barcode area BC of the image data received in the step 336 (step 349). When the determination is negative, each inspection terminal 32 once stores the image data and so on received in the step 336 to the hard disk (step 351), and waits until the next image data and so on are transmitted. When the determination is affirmative, each inspection terminal 32 image-recognizes the mark “ [symbol] ” inside the second reference position recognition area RPF2 of which area is smaller than the first reference position recognition area RPF1 (further acquires the pattern information by clipping the mark “ [symbol] ” if necessary), searches the coordinate matching with the pattern information of the mark “ [symbol] ” of the updated registration form information, clips the inspection area EF and the barcode area BC by using the position of the mark “ [symbol] ”, namely, the clipping reference position as the reference (step 350), and the process goes to step 352. In succeeding steps 353 to 362, each inspection terminal 32 performs the inspection by clipping the characters of each inspection area EF as same as in the steps 322 to 332, transmits the inspection result for one page to the inspection server 31, and the process returns to the step 334.

When the determination in the step 334 is negative, each inspection terminal 32 determines whether or not there is not-processed image data (the image data corresponding to the second page of the multi-form and the corresponding image index) of the image data and so on once stored to the hard disk in the steps 319, 348, 351, and so on (step 364). When there is the not-processed image data, each inspection terminal 32 determines whether or not there is an image of which page is specified by each inspection terminal 32 (in other words, whether or not the image corresponding to the first page of the multi-form is already processed by the inspecting terminal) (step 368). When there is the image of which page is specified, each inspection terminal 32 reads the image data and soon stored in the hard disk in the step 370, clips the characters of each inspection area EF to perform the inspection as same as in the steps 322 to 332, or the steps 353 to 362, transmits the inspection result for one page to the inspection server 31, and the process returns to the step 334. However, in the process corresponding to the step 328 or 358, each inspection terminal 32 is able to grasp the relationship between the image index and the physical page of the continuous business form F as for the image on the first page of the multi-form in which the barcode is included, as stated above. Each inspection terminal 32 therefore calculates an offset value by asking a difference between the image index of the image read from the hard disk and the image index of the image of which page in the continuous business form F is already known. Each inspection terminal 32 thereby estimates (determines) a page in the continuous business form F of the image read from the hard disk (also refer to FIG. 16) by adding the calculated offset value to the number of pages of the image of which page in the continuous business form F is known. Incidentally, the inspection server 31 is able to decrease the not-processed image data stored in the hard disk by being informed of the state that the page in the continuous business form F of the image index of a certain image data is known at the other inspecting terminal (step 430 in FIG. 13), or by informing the inspection terminal 32 other than the inspection terminal 32 from which the state is reported of the correspondence between the image index and the physical page of the continuous business form F (not shown in FIG. 12 and FIG. 13) after a predetermined time has passed from the time being informed of the state. Besides, it is preferable to ask the offset value by using the image index of the image of which page is known near to the image index of the image read from the hard disk, when the page in the continuous business form F of the image read from the hard disk is estimated. On the other hand, when the not-processed image data does not exist (when it is determined to be negative in the step 364), or the image of which page is specified does not exist (when it is determined to be negative in the step 368), each inspection terminal 32 determines whether or not the deletion instruction of the inspection job data is transmitted from the inspection server 31 (refer to the step 372 and the step 448 in FIG. 13). When the determination is negative, the process returns to the step 334. When the determination is affirmative, each inspection terminal 32 deletes the inspection job data (step 374), and terminates the process.

According to this aspect, when the first page of the multi-form is processed (when it is determined to be affirmative in the steps 318, 346 and 349), each inspection terminal 32 decodes the character string inside the inspection area EF, determines the page in the continuous business form F of the image data received from the image processing unit based on the character string inside the uniqueness specific area and the inspection job data (correct solution information), and grasps the correspondence between the image index and the physical page of the continuous business form F. When the second page of the multi-form is processed (when it is determined to be negative in the steps 318, 346 and 349), each inspection terminal 32 once stores the image data and image index received from the image processing unit to the hard disk (steps 319, 348 and 351), and estimates the page in the continuous business form F of the image data read from the hard disk by using the relationship between the image index of the image data read from the hard disk and the image index of the image data of which page in the continuous business form F is already known when there is the image (data) of which page is identified (step 368). Accordingly, as shown in FIG. 16, the linkage between each page in the continuous business form F of the multi-form and the inspection job data (correct solution information) is established, to thereby grasp the physical page. Further, it is possible to estimate the page in the continuous business form F of the image data read from the hard disk by using the relationship between the image index of the image data read from the hard disk and the image index of the image data of which page in the continuous business form F is already known, namely, by the similar process to the process of the second page of the multi-form, even in a case when the barcode in itself cannot be recognized because the form is dirty or the printing is blurred. In this case, whether the image data belongs to the first page or the second page of the multi-form may be grasped by referring to the inspection job data so as not to make a mistake in the clipping of the inspection area EF.

In the above-stated aspect, the example is shown in which the process is performed sequentially after the correspondence between the image index and the physical page of the continuous business form F is known when the second page of the multi-form is processed (step 370), but all of the images of the second page of the multi-form are stored in the hard disk, and the process of the second page of the multi-form may be performed in bulk after the correspondence is known. In the above-stated aspect, the multi-form business form in which the first page and the second page constitute one unit as the continuous business form F is exemplified, but the present invention is not limited to the aspect. For example, it goes without saying that a multi-form business form in which a first page, a second page and a third page constitute one unit can be used. In this case, the forms of the second page and the third page may be different. In the above-stated aspect, the example is shown in which information of the barcode in itself is not used, but for example, sequential numbers are supplied to the information of the barcode in itself as shown in FIG. 16, and a correspondence among the physical page of the continuous business form F, the barcode and the correct solution information may be taken.

In the above description, the example is shown in which the multi-form business form is used for the continuous business form F, but it goes without saying that a single-form business form can be used.

Further, in the above embodiment and aspect, the example is shown that each inspection terminal 32 image-recognizes and decodes the barcode inside the barcode area BC with reference to the inspection job data in step 321, determines whether or not decoded barcode information matches with the data of the barcode in the inspection job data, and when the determination is affirmative, the process goes to step 322, and when determination is negative, each inspection terminal 32 informs the inspecting server of the fact. However, the inspection terminal 32 may determine whether or not the uniqueness specific area is printed, and an affirmative determination is made, the inspection terminal 32 may determine based upon the updated registration form information whether or not the area is the printing of the barcode or the character string. That is, when the area is the barcode printing, the inspection terminal 32 decodes the barcode to convert into the character string, and searches (retrieves) the character string in the field number corresponding to the uniqueness specific area of the inspection job data to specify the page to which the received image data for one page corresponds. When the area is the character string printing, the inspection terminal 32 clips the character image one character by one character from the image in the area, and computes feature amounts obtained by computing feature vectors about slopes of respective small areas in an image forming direction, and multiplying the respective feature vectors by weight coefficients, and then searches the character string in the field number corresponding to the uniqueness specific area of the inspection job data having the feature amount matching with the feature amount of each character in the uniqueness specific area (the same character string) to specify the page to which the received image data for one page corresponds. While, when the determination is negative, the inspection terminal 32 informs the inspecting server of the fact.

Consequently, “in a print inspecting apparatus which inspects characters printed on a multi-form business form by a printer, the print inspecting apparatus” can be included in a range of the claims, “including:

an acquiring unit acquiring correct solution information representing information of a correct solution of a character printed on the form by the printer, which is associated with a plurality of printing areas within one page on which a character string is printed and page information;

a conveying unit conveying the form in one direction;

an image reading unit reading an image on the form conveyed by the conveying unit;

an image clipping unit clipping an image of a predetermined area from the image read by the image reading unit, and supplying a sequential image index to the clipped image;

a setting unit setting a plurality of areas inside the predetermined area with correspond to the predetermined area clipped by the image clipping unit and the printing areas, and setting a specific mark printed by the printer inside the predetermined area or an area of a specific mark printed on the form in advance;

a determining unit determining whether or not the specific mark exists inside the mark area set by the setting unit from among the image clipped by the image clipping unit;

a storage unit storing the image clipped by the image clipping unit and the supplied image index in accordance with a determination result of the determining unit;

a decoding unit decoding a character string inside the plurality of areas from among the image of the predetermined area clipped by the image clipping unit in accordance with the determination result of the determining unit; and

a page determining unit determining a page in the form of the image clipped by the image clipping unit based on the character string in the plurality of areas decoded by the decoding unit and the correct solution information acquired by the acquiring unit”.

“In a print inspecting apparatus which inspects characters printed on a form by a printer, the print inspecting apparatus” can be included in a range of the claims, “including:

an acquiring unit acquiring correct solution information representing information of a correct solution of a character printed on the form by the printer, which is associated with a plurality of printing areas within one page on which a character string is printed and page information;

a conveying unit conveying the form in one direction;

an image reading unit reading an image on the form conveyed by the conveying unit;

an image clipping unit clipping an image of a predetermined area from the image read by the image reading unit, and supplying a sequential image index to the clipped image;

a setting unit setting a plurality of areas inside the predetermined area with correspond to the predetermined area clipped by the image clipping unit and the printing areas, and setting an area of a barcode printed by the printer inside the predetermined area;

a barcode recognizing unit determining whether or not the barcode exists inside the barcode area set by the setting unit from the image clipped by the image clipping unit;

a storage unit storing the image clipped by the image clipping unit and the supplied image index;

a decoding unit decoding a character string inside the plurality of areas from the image of the predetermined area clipped by the image clipping unit; and

a page determining unit determining a page in the form of the image clipped by the image clipping unit based on the character strings in the plurality of areas decoded by the decoding unit and the correct solution information acquired by the acquiring unit,

in which when the determination by the barcode recognizing unit is affirmative, the decoding unit decodes the character string inside the plurality of areas from the image of the predetermined area clipped by the image clipping unit, the page determining unit determines the page in the form of the image clipped by the image clipping unit and grasps a correspondence between the image index supplied by the image clipping unit and the page of the correct solution information acquired by the acquiring unit,

in which when the determination by the barcode recognizing unit is negative, the storage unit stores the image clipped and the image index supplied by the image clipping unit, the page determining unit grasps the correspondence between the image index supplied by the image clipping unit and the page of the correct solution information acquired by the acquiring unit as for at least one image clipped by the image clipping unit, and thereafter, the decoding unit reads the image and the image index stored in the storage unit and decodes the character string inside the plurality of areas from the image of the predetermined area clipped by the image clipping unit, and the page determining unit determines the page in the form of the image clipped by the image clipping unit.

This application is based upon and claims the benefit of priority of the prior Japanese Patent Application No. 2007-338513, filed on Dec. 28, 2007, Japanese Patent Application No. 2007-338571, filed on the same date, Japanese Patent Application No. 2007-338660, filed on the same date, the entire contents of which are incorporated herein by reference.

What is claimed is:

1. A print inspecting apparatus that inspects characters printed on a form by a printer, comprising:
an acquiring unit which acquires correct solution information representing information on a correct solution of a character string and/or a code printed on the form by the printer, which is associated with a plurality of printing areas in one page on which the character string and/or the code is printed and page information;
a conveying unit which conveys the form in one direction;
an image reading unit which reads an image on the form being conveyed by the conveying unit;
an image clipping unit which clips a plurality of areas from the image read by the image reading unit;
a setting unit which sets a plurality of areas to be clipped by the image clipping unit corresponding to the printing areas in advance;
a decoding unit which decodes a character string and/or a code in the plurality of areas from the image of the plurality of areas clipped by the image clipping unit; and
a page determining unit which determines that the character string in the plurality of areas decoded by the decoding unit falls under that of what page in the form, based on the character string in the plurality of areas decoded by the decoding unit and the correct solution information acquired by the acquiring unit.

2. The print inspecting apparatus according to claim 1, further comprising a uniqueness confirming unit which confirms uniqueness of the character string and/or the code printed on each page relative to all pages of the correct solution information, by combining the character strings in the plurality of printing areas of the correct solution information acquired by the acquiring unit.

3. The print inspecting apparatus according to claim 2, further comprising a selecting unit for selecting a uniqueness confirming area of which uniqueness is to be confirmed by the uniqueness confirming unit from among the plurality of areas set by the setting unit in advance.

4. The print inspecting apparatus according to claim 3, wherein the uniqueness confirming unit confirms the uniqueness of each page relative to all pages of the correct solution information in the uniqueness confirming area selected by the selecting unit.

5. The print inspecting apparatus according to claim 4, wherein the uniqueness confirming unit determines whether there is the uniqueness in the character string and/or the code printed on each page relative to all pages of the correct solution information by combining the character strings in the plurality of printing areas of the correct solution information acquired by the acquiring unit, when an affirmative determination is made, determines whether there is the uniqueness in the character string and/or the code printed on each page even if the number of the uniqueness confirming areas selected by the selecting unit is decreased, when this determination is affirmative, decreases the number of the uniqueness confirming areas, and when a negative determination is made, increases the area which is not selected by the selecting unit among the plural areas set by the setting unit as the uniqueness confirming areas in addition to the uniqueness confirming areas selected by the selecting unit.

6. The print inspecting apparatus according to claim 1, wherein a mark representing a page is not printed on the form.

7. The print inspecting apparatus according to claim 1, wherein the image reading unit reads the image by each page on the form being conveyed by the conveying unit, the image clipping unit clips the plurality of areas from the image read by the image reading unit by each page.

8. The print inspecting apparatus according to claim 7, wherein the decoding unit decodes the image of the character string in the plurality of areas clipped by the image clipping unit by clipping one character by one character.

9. The print inspecting apparatus according to claim 8, wherein the decoding unit has a plurality of computers capable of decoding the image of the character string one character by one character in the plurality of areas clipped by the image clipping unit.

10. The print inspecting apparatus according to claim 9, wherein the computer computes a feature amount of each clipped character.

11. The print inspecting apparatus according to claim 10, wherein the computer divides the image of the each clipped character into small areas to use an image forming direction of each small area as an element of the feature amount.

12. The print inspecting apparatus according to claim 1, wherein the form is a continuous form.

13. The print inspecting apparatus according to claim 1, wherein the image reading unit reads the images on both faces of the form being conveyed by the conveying unit.
